(19) United States
(12) Patent Application Publication
(10) Pub. No.: US 2009/0198028 A1
(43) Pub. Date: Aug. 6, 2009

(54) 1,2-dithiol-3-thiones as chain-transfer agents in free-radical polymerization reactions

(75) Inventors: Szilard Csihony, Weinheim (DE); Arno Lange, Bad Dürkheim (DE); Yvonne Dieckmann, Hassloch (DE); Monica Haag, Ludwigshafen (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/305,499

(22) PCT Filed: Jun. 20, 2007
(86) PCT No.: PCT/EP2007/056161

§ 371 Date: Dec. 18, 2008

(30) Foreign Application Priority Data
Jun. 21, 2006 (EP) 06115793.9

(51) Int. Cl. C08F 2/38; C08F 228/06

(52) U.S. Cl. 526/204; 526/256

(57) ABSTRACT

The present invention relates to a process for the preparation of polymers by controlled free radical polymerization of monomers capable of free radical polymerization in the presence of 1,2-dithiol-3-thiones as chain transfer agents.

The present invention relates to a process for the preparation of polymers by controlled free radical polymerization of monomers capable of free radical polymerization in the presence of 1,2-dithiol-3-thiones as chain transfer agents.

Free radical polymerization is one of the most important processes for the industrial production of numerous important chemical products, in particular of plastics. The importance of free radical polymerization is based in particular on the variety of the monomers which can be used, the insensitivity of the process to impurities, and the comparatively simple feasibility of the polymerization. Thus, mass polymers, such as polystyrene, polymethyl methacrylate, polyethylene and the like can be economically prepared. The limits of this process are the limited controllability of the molar masses and the limitation to relatively simple polymer architectures. Some of these disadvantages are compensated by so-called “living” processes, such as cationic or anionic living polymerization. The term “living” in this context means that, in the living polymerizations, termination reactions of the reactive, i.e. of the growing, chain ends are substantially suppressed. In the case of the simultaneous initiation of the polymerization, all macroradicals therefore grow at approximately the same rate and all chains always have substantially the same chain length. The polymers forming are therefore distinguished by a relatively narrow molecular weight distribution, which is expressed in a low polydispersity index (PDI=M_{w}/Mₙ; M_{w}=weight average molecular weight; Mₙ=number average molecular weight). The ionic living processes therefore make it possible to establish the molar masses of the products in a targeted manner. Moreover, it is possible by means of them to prepare more complex structures, such as, for example, block copolymers. A disadvantage of the living ionic processes is, however, that they set high requirements with regard to the purity of the reactants used and frequently also require low temperature techniques so that they are economically not so attractive.

In recent years, however, it has been possible to develop controlled (=living) processes even in the case of free radical polymerizations. Controlled free radical polymerizations permit exact control of the chain length, of the terminal groups and of the microarchitecture of the polymer chains forming. Thus, it has in the meantime been possible to prepare block copolymers, gradient copolymers, star polymers and dendrimeric, branched and terminal group-functionalized polymers also by free radical polymerizations. At the same time this novel living free radical polymerization technique is superior to the conventional living ionic polymerization processes in some important respects: thus, substantially more monomer classes can be polymerized; furthermore, the experimental effort is a great deal less since the requirements with regard to the purity of the reactants are substantially lower than in the case of ionic polymerizations and as a rule low temperature techniques are also not required. Moreover, active centers which can be used for further reactions are retained in the polymer.

The basic principle of all living polymerizations is the suppression of the termination reaction of the reactive; i.e. growing, chain ends. While in ionic polymerization termination between two reactive-ends (two anions or two cations) is in principle impossible, in free radical polymerization the chain ends (two radicals) can react with one another by recombination or disproportionation or lose heir free radical function by transfer reactions and thus lead to a chain termination. These termination reactions are minimized in the controlled or living free radical polymerization by a dynamic equilibrium between a relatively small number of active, i.e. growing, free radicals and a relatively large number of so-called “sleeping” radicals. The sleeping radical centers are protected and cannot recombine with one another, i.e. the concentration of reactive chain ends is dramatically reduced, with the result that secondary reactions are suppressed. After an activation reaction, the sleeping centers can then be further polymerized. The conversion of the reactive chain ends into sleeping species can be effected by formation of C—S, C—O—N or, C-halogen bonds. Depending on the reagent with which the conversion into sleeping species is carried out, a distinction is made between the following techniques
Atom Transfer Radical Polymerization (ATRP), in which free radicals are in equilibrium with the corresponding alkyl halides (sleeping species) via a redox process,
Nitroxide Mediated Radical Polymerization (NMRP), in which stable radicals based on nitroxides, such as TEMPO, react with the growing chain ends reversibly to give alkoxyamines, and
Reversible Addition Fragmentation Polymerization (RAFT).

In the RAFT polymerization, the dithio compound, generally special dithio esters or xanthogenates, are used as chain transfer agents in processes known to date. The mechanism of the transformation of the free radical-centers into sleeping radicals with the aid of the dithio compound and their liberation again are shown by way of example in the following scheme. For illustration, the initiator chosen was a homolytically cleavable free radical initiator and the dithio compound chosen was a dithio ester. However, it is assumed that the mechanism takes place analogously or at least similarly even when other initiators and/or other dithio compounds are chosen as chain transfer agents.

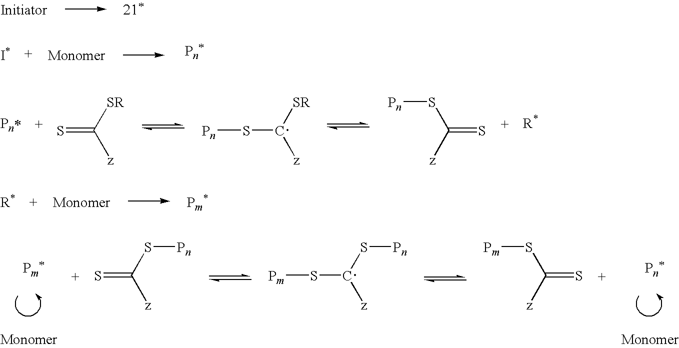

The formation of the initiator radicals by the disintegration of a conventional initiator I₂, as also used in the free radical polymerization, into two initiator radicals I* takes place in the first step. In the second step, this initiator radical I* reacts with a monomer. This is to be regarded as the start of the chain and leads to a Pₙ* radical. The Pₙ* radical reacts in the third step with the dithio component, which acts as a chain transfer reagent, and leads to the formation of a more or less stable intermediate radical. This has two possibilities for further reaction: firstly, it can undergo the reverse reaction and liberate the Pₙ* radical again. Secondly, it can also liberate the radical R as a R* radical. By a suitable choice of the group Z and the radical R, the second route of radical liberation from the transitional radical is preferred. The liberated radical R* is in turn capable of initiating a new polymer chain by reacting with the monomer to give the species Pₘ*. The species Pₘ* and Pₙ* have the same reactivity with respect to the reaction with further monomers but also with the dithio component. This results in an equilibrium between the transitional radical species and the two radicals Pₙ* and Pₘ*. The adjustment of this equilibrium is responsible for controlling the polymerization.

The activity of the dithio component as a chain transfer agent is substantially influenced by two aspects. Thus, the radical Z is responsible for stabilizing the dithio transitional radical. The better this intermediate compound is stabilized, the more the formation of the transitional species is promoted. The second component, which has a considerable influence on the reactivity of the chain transfer reagent, is the radical R, which firstly must be a good leaving group but simultaneously must be capable of reacting with the monomer to initiate a new polymer chain.

In particular, the dithio carboxylic esters or salts and xanthogenates, i.e. the salts or esters of dithiocarbonic acid, are used in the prior art as chain transfer reagents in RAFT polymerization.

Thus, WO 2004/014967 describes the free radical controlled polymerization of acrylic acid (salts) to give homo- or copolymers in the presence of sodium salts of α-substituted β-carboxylated xanthogenates, which are obtained by the reaction of a potassium xanthogenate with the sodium salt of 2-bromopropionic acid, as a chain transfer agent.

WO 99/31144 describes the controlled free radical polymerization of a multiplicity of monomers using various, in some cases very complex dithio esters, dithiocarbamates and xanthogenates as chain transfer reagents.

US-A-2003/0195310 describes the free radical controlled polymerization for the preparation of linear, polymeric ABA copolymers and star polymers in the presence of various dithio esters and trithiocarbonic esters as chain transfer agents.

EP-A-1205492 describes a process for the preparation of homo- and copolymers by RAFT miniemulsion polymerization in the presence of various dithio esters.

WO 2004/056880 describes a process for the preparation of multiblock copolymers in the presence of various dithio esters as chain transfer agents.

A disadvantage of all these dithio compounds described in the prior art is that they are obtainable only via complicated syntheses and/or their synthesis starts from relatively expensive starting materials.

It was therefore an object of the present invention to provide a chain transfer reagent for free radical controlled polymerization which is simpler to prepare.

The object was achieved by a process for the preparation of polymers by controlled free radical polymerization, in which at least one monomer capable of free radical polymerization is polymerized in the presence of at least one-free radical initiator and at least one chain transfer agent of the formula I

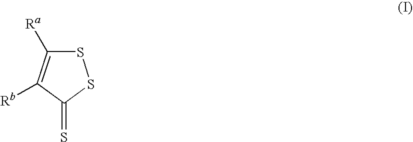

where
R^{a} and R^{b}, independently of one another, are H, halogen, OH, SH, CN, nitro, amino, formyl, carboxyl, thiocarboxyl (—C(S)OH), dithiocarboxyl (CSSH), aryl, C₁-C₈₀-alkyl, C₂-C₈₀-alkenyl, C₂-C₈₀-alkynyl, C₁-C₈₀-alkyloxy, C₂-C₁₀-alkenyloxy, C₂-C₁₀-alkynyloxy, C₁-C₁₀-alkylthio, C₂-C₁₀-alkenylthio, C₂-C₁₀-alkynylthio, C₁-C₁₀-alkylcarbonyl, C₁-C₁₀-alkylthiocarbonyl, C₁-C₁₀-alkylcarbonyloxy, C₁-C₁₀-alkylthiocarbonyloxy, C₁-C₁₀-alkyloxycarbonyl, C₁-C₁₀-alkyloxythiocarbonyl, C₁-C₁₀-alkyloxycarbonyloxy, C₁-C₁₀-alkyloxythiocarbonyloxy, C₁-C₁₀-alkylamino or di-(C₁-C₁₀-alkyl)amino, it being possible for alkyl, alkenyl and alkynyl in the 19 abovementioned radicals to be unsubstituted, to be partly or completely halogenated and/or to carry 1, 2, 3 or 4 identical or different substituents which are selected from OH, C₁-C₁₀-alkoxy, SH, C₁-C₁₀-alkylthio, CN, nitro, amino, C₁-C₁₀-alkylamino, di(C₁-C₁₀-alkyl)amino, formyl, C₁-C₁₀-alkylcarbonyl, C₁-C₁₀-alkylthiocarbonyl, carboxyl, thiocarboxyl, C₁-C₁₀-alkoxycarbonyl, C₁-C₁₀-alkoxythiocarbonyl, C₁-C₁₀-alkylcarbonyloxy, C₁-C₁₀-alkylthiocarbonyloxy, C₁-C₁₀-alkoxycarbonyloxy, C₁-C₁₀-alkoxythiocarbonyloxy and aryl,
or R^{a} and R^{b}, together with the carbon atoms to which they are bonded, form a 5- or 6-membered saturated or unsaturated ring which may comprise 1, 2 or 3 heteroatoms which are selected from O, S and N and/or 1 or 2 carbonyl groups as ring members, it being possible for the ring to carry 1, 2 or 3 substituents which are selected from halogen, OH, C₁-C₄-alkyl, C₁-C₄-halo alkyl, C₁-C₄-alkoxy and C₁-C₄-haloalkoxy,
   and, optionally, at least one solvent.

The terms “chain transfer agent” and “chain transfer-reagent” are used synonymously in the context of the following invention.

In the context of the present invention, C₁-C₄-alkyl is a linear or branched alkyl radical having 1 to 4 carbon atoms. Examples of this are methyl, ethyl, propyl, isopropyl, n-butyl, sec-butyl, isobutyl and tert-butyl.

C₁-C₆-alkyl is a linear or branched alkyl radical having 1 to 6 carbon atoms. Examples of this are methyl, ethyl, propyl, isopropyl, n-butyl, sec-butyl, isobutyl, tert-butyl, pentyl, isopentyl, neopentyl, hexyl, isohexyl and positional isomers thereof.

C₁-C₁₀-alkyl is a linear or branched alkyl radical having 1 to 10 carbon atoms. Examples of this in addition to the examples already mentioned in the case of C₁-C₆-alkyl are heptyl, octyl, 2-ethylhexyl, nonyl and decyl and positional isomers thereof.

C₁-C₂₀-alkyl is a linear or branched alkyl radical having 1 to 20 carbon atoms. Examples of this in addition to the examples already mentioned in the case of C₁-C₁₀-alkyl are undecyl, dodecyl, tridecyl, tetradecyl, pentadecyl, hexadecyl, heptadecyl, octadecyl, nonadecyl and eicosyl and positional isomers thereof.

C₁-C₃₀-alkyl is a linear or branched alkyl radical having 1 to 30 carbon atoms. Examples of this in addition to the examples already mentioned in the case of C₁-C₂₀-alkyl are henicosyl, docosyl, tricosyl, tetracosyl, pentacosyl, hexacosyl, heptacosyl, octacosyl, nonacosyl and squalyl and positional isomers thereof.

C₁-C₄₀-alkyl is a linear or branched alkyl radical having 1 to 40 carbon atoms. Examples of this in addition to the examples already mentioned in the case of C₁-C₃₀-alkyl are the higher homologs having 31 to 40 carbon atoms and the positional isomers thereof.

C₁-C₈₀-alkyl is a linear or branched alkyl radical having 1 to 80 carbon atoms. Examples of this in addition to the examples already mentioned in the case of C₁-C₄₀-alkyl are the higher homologs having 41 to 80 carbon atoms and the positional isomers thereof.

C₄-C₁₂-alkyl is a linear or branched alkyl radical having 4 to 12 carbon atoms. Examples of this are n-butyl, sec-butyl, isobutyl, tert-butyl, pentyl, isopentyl, neopentyl, hexyl, isohexyl, heptyl, octyl, 2-ethylhexyl, nonyl, decyl, undecyl and dodecyl and positional isomers thereof.

C₄-C₂₀-alkyl is a linear or branched alkyl radical having 4 to 20 carbon atoms. Examples of this in addition to the examples already mentioned in the case of C₄-C₁₂-alkyl are tridecyl, tetradecyl, pentadecyl, hexadecyl, heptadecyl, octadecyl, nonadecyl and eicosyl and positional isomers thereof.

C₄-C₃-alkyl is a linear or branched alkyl radical having 4 to 30 carbon atoms. Examples of this in addition to the examples already mentioned in the case of C₄-C₂₀-alkyl are henicosyl, docosyl, tricosyl, tetracosyl, pentacosyl, hexacosyl, heptacosyl, octacosyl, nonacosyl and squalyl and positional isomers thereof.

C₄-C₄₀-alkyl is a linear or branched alkyl radical having 4 to 40 carbon atoms. Examples of this in addition to the examples already mentioned in the case of C₄-C₃₀-alkyl are the higher homologs having 31 to 40 carbon atoms and the positional isomers thereof.

C₄-C₈₀-alkyl is a linear or branched alkyl radical having 4 to 80 carbon atoms. Examples of this in addition to the examples already mentioned in the case of C₄-C₄₀-alkyl are the higher homologs having 41 to 80 carbon atoms and the positional isomers thereof.

Higher alkyl radicals, especially those having more than 6 carbon atoms, e.g. having 8 to 10, 8 to 20, 8 to 30, 8 to 40 or 8 to 80 carbon atoms are preferably derived from oligomers or polymers of lower alkenes, especially of C₂-C₆-alkenes, such as ethylene, propene, 1- and 2-butene, isobutene, 1- and 2-pentene or 1-, 2- and 3-hexene.

C₂-C₄-hydroxyalkyl is a linear or branched alkyl radical having 2 to 4 carbon atoms, in which one or more hydrogen atoms are replaced by a hydroxyl group, each carbon atom carrying as a rule not more than one hydroxyl group. Examples of this are 2-hydroxyethyl, 2- and 3-hydroxypropyl, 2,3-dihydroxypropyl, 4-hydroxybutyl and the like.

C₂-C₆-hydroxyalkyl is a linear or branched alkyl radical having 2 to 6 carbon atoms, in which one or more hydrogen atoms are replaced by a hydroxyl group, each carbon atom carrying as a rule not more than one hydroxyl group. Examples of this in addition to the examples mentioned in the case of C₂-C₄-hydroxyalkyl are pentaerythrityl and sorbityl.

C₂-C₁₀-hydroxyalkyl is a linear or branched alkyl radical having 2 to 10 carbon atoms, in which one or more hydrogen atoms are replaced by a hydroxyl group, each carbon atoms carrying as a rule not more than one hydroxyl group. Examples of this are 2-hydroxyethyl, 2- and 3-hydroxypropyl, 2,3-dihydroxypropyl, 4-hydroxybutyl, pentaerythrityl, sorbityl and the like.

C₁-C₆-haloalkyl is a C₁-C₆-alkyl radical in which at least one hydrogen atom is replaced by a halogen atom, e.g. by F, Cl or Br. C₁-C₄-haloalkyl is a C₁-C₄-alkyl radical in which at least one hydrogen atom is replaced by a hydrogen atom, e.g. by F, Cl or Br. Examples of these are chloromethyl, dichloromethyl, trichloromethyl, fluoromethyl, difluoromethyl, trifluoromethyl, 1,1-difluoroethyl, 2,2,2-trifluoroethyl, pentafluoroethyl, 3,3,3-trifluoropropyl, 1,1-dichloroethyl, 2,2,2-trichloroethyl, pentachloroethyl, 3,3,3-trichloropropyl and the like.

Silyl-substituted C₁-C₁₀-alkyl is a linear or branched alkyl radical having 1 to 10 carbon atoms, in which at least one hydrogen atom is substituted by a silyl group SiR′R″R′″, where R′, R″ and R′″, independently of one another, are C₁-C₆-alkyl or C₁-C₆-alkoxy. Examples of this are trimethoxysilylpropyl, triethoxysilylpropyl, tripropoxysilylpropyl, tributoxysilylpropyl, dimethoxymethylsilylpropyl, diethoxymethylsilylpropyl, dipropoxymethylsilylpropyl, diisopropoxymethylsilylpropyl, dibutoxymethylsilylpropyl, trimethoxysilylethyl, triethoxysilylethyl, tripropoxysilylethyl, tributoxysilylethyl, dimethoxymethylsilylethyl, diethoxymethylsilylethyl, dipropoxymethylsilylethyl, diisopropoxymethylsilylethyl, dibutoxymethylsilylethyl, trimethoxysilylmethyl, triethoxysilylmethyl, tripropoxysilylmethyl, tributoxysilylmethyl, dimethoxymethylsilylmethyl, diethoxymethylsilylmethyl, dipropoxymethylsilylmethyl, diisopropoxymethylsilylmethyl, dibutoxymethylsilylmethyl and the like.

Amine- or ammonium-substituted C₁-C₁₀-alkyl is a linear or branched alkyl radical having 1 to 10 carbon atoms, in which at least one hydrogen atom, e.g. 1, 2 or 3 hydrogen atoms, preferably one hydrogen atom, is substituted by an amino group NR′R″ or an ammonium group NR′R″R′″, where R′, R″ and R′″, independently of one another, are H, C₁-C₆-alkyl or C₁-C₆-hydroxyalkyl. Examples of this are 2-aminoethyl, 2-(methylamino)ethyl, 2-(methylammonium)ethyl, 2-(dimethylamino)ethyl, 2-(dimethylammonium)ethyl, 2-(trimethylammonium)ethyl, 2-(ethylamino)ethyl, 2-(ethylammonium)ethyl, 2-(diethylamino)ethyl, 2-(diethylammonium)ethyl, 2-(triethylammonium)ethyl, 2-(propylamino)ethyl, 2-(propylammonium)ethyl, 2-(dipropylamino)ethyl, 2-(dipropylammonium)ethyl, 2-(tripropylammonium)ethyl, 3-aminopropyl, 3-(methylamino)propyl, 3-(methylammonium)propyl, 3-(dimethylamino)propyl, 3-(dimethylammonium)propyl, 3-(trimethylammonium)propyl, 3-(ethylamino)propyl, 3-(ethylammonium)propyl, 3-(diethylamino)propyl, 3-(diethylammonium)propyl, 3-(triethylammonium)propyl, 3-(propylamino)propyl, 3-(propylammonium)propyl, 3-(dipropylamino)propyl, 3-(dipropylammonium)propyl, 3-(tripropylammonium)propyl and the like. Of course, a counteranion, e.g. chloride, bromide or sulfate, may be present in the case of ammonium-substituted alkyl.

Sulfo or sulfonate-substituted C₁-C₁₀-alkyl is a linear or branched alkyl radical having 1 to 10 carbon atoms, in which at least one hydrogen atom, e.g. 1, 2 or 3 hydrogen atoms, preferably one hydrogen atom, is substituted by a sulfo group (—SO₃H) or a sulfonate group. The term “sulfonate group” relates both to sulfonic acid salts —SO₃.(M^{x+})_{1/x} and to sulfonic acid esters —SO₃R. (M^{x+})_{1/x} is a metal cation equivalent or an ammonium ion (NR^{α}R^{β}R^{γ}R^{δ})⁺. Preferably, M is an alkali metal, such as lithium, sodium or potassium, an alkaline earth metal, such as calcium or magnesium, a metal of the third, main group, such as aluminum, or a transition metal, such as iron or nickel. Preferably, M is an alkali metal, in particular sodium or potassium. R^{α}, R^{β}, R^{γ} and R^{δ}, independently of one another, are H, C₁-C₁₀-alkyl or C₂-C₁₀-hydroxyalkyl. R is C₁-C₁₀-alkyl or C₂-C₁₀-hydroxyalkyl. Sulfonate-substituted C₁-C₁₀-alkyl is preferably a linear or branched alkyl radical having 1 to 10 carbon atoms, in which a hydrogen atom is substituted by a sulfonic acid salt group SO₃.(M^{x+})_{1/x}.

C₁-C₄-alkyloxy (or alkoxy) is a C₁-C₄-alkyl radical which is bound via an oxygen atom. Examples of this are methoxy, ethoxy, propoxy, isopropoxy, n-butoxy, 2-butoxy, isobutoxy and tert-butoxy.

C₁-C₆-alkyloxy (or alkoxy) is a C₁-C₆-alkyl radical which is bound via an oxygen atom. Examples of this in addition to the examples mentioned for C₁-C₄-alkoxy are pentyloxy and hexyloxy and positional isomers thereof.

C₁-C₁₀-alkyloxy (or alkoxy) is a C₁-C₁₀-alkyl radical which is bound via an oxygen atom. Examples of this in addition to the examples mentioned for C₁-C₆-alkoxy are heptyloxy, octyloxy, 2-ethylhexyloxy, nonyloxy, decyloxy and positional isomers thereof.

C₁-C₄-alkylthio is a C₁-C₄-alkyl radical which is bound via a sulfur atom. Examples of this are methylthio, ethylthio, propylthio, isopropylthio, butylthio, sec-butylthio, isobutylthio and tert-butylthio.

C₁-C₆-alkylthio is a C₁-C₆-alkyl radical which is bound via a sulfur atom. Examples of this in addition to the examples mentioned for C₁-C₄-alkylthio are pentylthio, hexylthio and positional isomers thereof.

C₁-C₁₀-alkylthio is a C₁-C₁₀-alkyl radical which is bound via a sulfur atom. Examples of this in addition to the examples mentioned for C₁-C₆-alkylthio are heptylthio, octylthio, 2-ethylhexylthio, nonylthio, decylthio and positional isomers thereof.

C₁-C₁₀-alkylcarbonyl is a group of the formula R—CO—, where R is a C₁-C₁₀-alkyl group as defined above. Examples are acetyl, propionyl and the like.

C₁-C₁₀-alkylthiocarbonyl is a group of the formula R—CS—, where R is a C₁-C₁₀-alkyl group as defined above. Examples are thioacetyl, thiopropionyl and the like.

C₁-C₁₀-alkylcarbonyloxy is a group of the formula R—CO—O—, where R is a C₁-C₁₀-alkyl group as defined above. Examples are acetoxy, propionyloxy and the like.

C₁-C₁₀-alkylthiocarbonyloxy is a group of the formula R—CS—O—, where R is a C₁-C₁₀-alkyl group as defined above. Examples are thioacetoxy, thiopropionyloxy and the like.

C₁-C₁₀-alkoxycarbonyl is a group of the formula R—CO—, where R is a C₁-C₁₀-alkoxy group as defined above. Examples are methoxycarbonyl, ethoxycarbonyl and the like.

C₁-C₁₀-alkoxythiocarbonyl is a group of the formula R—CS—, where R is a C₁-C₁₀-alkoxy group as defined above. Examples are methoxythiocarbonyl, ethoxythiocarbonyl and the like.

C₁-C₁₀-alkoxycarbonyloxy is a group of the formula R—CO—O—, where R is a C₁-C₁₀-alkoxy group as defined above. Examples are methoxycarbonyloxy, ethoxycarbonyloxy and the like.

C₁-C₁₀-alkoxythiocarbonyloxy is a group of the formula R—CS—O—, where R is a C₁-C₁₀-alkoxy group as defined above. Examples are methoxythiocarbonyloxy, ethoxythiocarbonyloxy and the like.

C₂-C₄-alkenyl is a monounsaturated aliphatic hydrocarbon radical having 2 to 4 carbon atoms. Examples of this are ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl and 2-methyl-2-propenyl.

C₂-C₆-alkenyl is a monounsaturated aliphatic hydrocarbon radical having 2 to 6 carbon atoms. Examples of this in addition to those mentioned for C₂-C₄-alkenyl are 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl and the like.

C₂-C₁₀-alkenyl is a monounsaturated aliphatic hydrocarbon radical having 2 to 10 carbon atoms. Examples of this in addition to those mentioned for C₂-C₆-alkenyl are 1-, 2- and 3-heptenyl, 1-, 2-, 3- and 4-octenyl, 1-, 2-, 3- and 4-nonenyl and 1-, 2-, 3-, 4- and 5-decenyl and positional isomers thereof.

C₂-C₂₀-alkenyl is a monounsaturated aliphatic hydrocarbon radical having 2 to 20 carbon atoms. Examples of this in addition to those mentioned for C₂-C₁₀-alkenyl are the higher homologs having 11 to 20 carbon atoms and positional, isomers thereof.

C₂-C₃₀-alkenyl is a monounsaturated aliphatic hydrocarbon radical having 2 to 30 carbon atoms. Examples of this in addition to those mentioned for C₂-C₂₀-alkenyl are the higher homologs having 21 to 30 carbon atoms and positional isomers thereof.

C₂-C₄₀-alkenyl is a monounsaturated aliphatic hydrocarbon radical having 2 to 40 carbon atoms. Examples of this in addition to those mentioned for C₂-C₃₀-alkenyl are the higher homologs having 31 to 40 carbon atoms and positional isomers thereof.

C₂-C₈₀-alkenyl is a monounsaturated aliphatic hydrocarbon radical having 2 to 80 carbon atoms. Examples of this in addition to those mentioned for C₂-C₄₀-alkenyl are the higher homologs having 41 to 80 carbon atoms and positional isomers thereof.

Higher alkenyl radicals, especially those having more than 6 carbon atoms, e.g. having 8 to 10, 8 to 20, 8 to 30, 8 to 40 or 8 to 80 carbon atoms, are preferably derived from oligomers or polymers of lower alkenes, especially of C₂-C₆-alkenes, such as ethylene, propene, 1- and 2-butene, isobutene, 1- and 2-pentene or 1-, 2- and 3-hexene.

C₂-C₄-alkynyl is a linear or branched aliphatic hydrocarbon radical having 2 to 4 carbon atoms and a triple bond in any position. Examples of this are ethynyl, 1-propynyl, 2-propynyl, 1-butynyl, 2-butynyl, 3-butynyl, 1-methyl-2-propynyl and the like.

C₂-C₆-alkynyl is a linear or branched aliphatic hydrocarbon radical having 2 to 6 carbon atoms and a triple bond in any position. Examples of this in addition to those mentioned for C₂-C₄-alkynyl are 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, 1-ethyl-1-methyl-2-propynyl and the like.

C₂-C₁₀-alkynyl is a linear or branched aliphatic hydrocarbon radical having 2 to 10 carbon atoms and a triple bond in any position. Examples of this in addition to those mentioned for C₂-C₆-alkynyl are the higher homologs having 7 to 10 carbon atoms and positional isomers thereof.

C₂-C₂₀-alkynyl is a linear or branched aliphatic hydrocarbon radical having 2 to 20 carbon atoms and a triple bond in any position. Examples of this in addition to those mentioned for C₂-C₁₀-alkynyl are the higher homologs having 11 to 20 carbon atoms and positional isomers thereof.

C₂-C₃₀-alkynyl is a linear or branched aliphatic hydrocarbon radical having 2 to 30 carbon atoms and a triple bond in any position. Examples of this in addition to those mentioned for C₂-C₂₀-alkynyl are the higher homologs having 21 to 30 carbon atoms and positional isomers thereof.

C₂-C₄₀-alkynyl is a linear or branched aliphatic hydrocarbon radical having 2 to 40 carbon atoms and a triple bond in any position. Examples of this in addition to those mentioned for C₂-C₃₀-alkynyl are the higher homologs having 31 to 40 carbon atoms and positional isomers thereof.

C₂-C₈₀-alkynyl is a linear or branched aliphatic hydrocarbon radical having 2 to 80 carbon atoms and a triple bond in any position. Examples of this in addition to those mentioned for C₂-C₄₀-alkynyl are the higher homologs having 41 to 80 carbon atoms and positional isomers thereof.

C₂-C₁₀-alkenyloxy is a C₂-C₁₀-alkenyl group, preferably C₃-C₁₀-alkenyl group, bound via an oxygen atom. Examples of this are 1-propenyloxy, 2-propenyloxy, 1-methylethenyloxy, 1-butenyloxy, 2-butenyloxy, 3-butenyloxy, 1-methyl-1-propenyloxy, 2-methyl-1-propenyloxy, 1-methyl-2-propenyloxy, 2-methyl-2-propenyloxy, 1-pentenyloxy, 2-pentenyloxy, 3-pentenyloxy, 4-pentenyloxy, 1-methyl-1-butenyloxy, 2-methyl-1-butenyloxy, 3-methyl-1-butenyloxy, 1-methyl-2-butenyloxy, 2-methyl-2-butenyloxy, 3-methyl-2-butenyloxy, 1-methyl-3-butenyloxy, 2-methyl-3-butenyloxy, 3-methyl-3-butenyl, 1,1-dimethyl-2-propenyloxy, 1,2-dimethyl-1-propenyloxy, 1,2-dimethyl-2-propenyloxy, 1-ethyl-1-propenyloxy, 1-ethyl-2-propenyloxy, 1-hexenyloxy, 2-hexenyloxy, 3-hexenyloxy, 4-hexenyloxy, 5-hexenyloxy, 1-methyl-1-pentenyloxy, 2-methyl-1-pentenyloxy, 3-methyl-1-pentenyloxy, 4-methyl-1-pentenyloxy, 1-methyl-2-pentenyloxy, 2-methyl-2-pentenyloxy, 3-methyl-2-pentenyloxy, 4-methyl-2-pentenyloxy, 1-methyl-3-pentenyloxy, 2-methyl-3-pentenyloxy, 3-methyl-3-pentenyloxy, 4-methyl-3-pentenyloxy, 1-methyl-4-pentenyloxy, 2-methyl-4-pentenyloxy, 3-methyl-4-pentenyloxy, 4-methyl-4-pentenyloxy, 1,1-dimethyl-2-butenyloxy, 1,1-dimethyl-3-butenyloxy, 1,2-dimethyl-1-butenyloxy, 1,2-dimethyl-2-butenyloxy, 1,2-dimethyl-3-butenyloxy, 1,3-dimethyl-1-butenyloxy, 1′,3-dimethyl-2-butenyloxy, 1,3-dimethyl-3-butenyloxy, 2,2-dimethyl-3-butenyloxy, 2,3-dimethyl-1-butenyloxy, 2,3-dimethyl-2-butenyloxy, 2,3-dimethyl-3-butenyloxy, 3,3-dimethyl-1-butenyloxy, 3,3-dimethyl-2-butenyloxy, 1-ethyl-1-butenyloxy, 1-ethyl-2-butenyloxy, 1-ethyl-3-butenyloxy, 2-ethyl-1-butenyloxy, 2-ethyl-2-butenyloxy, 2-ethyl-3-butenyloxy, 1,1,2-trimethyl-2-propenyloxy, 1-ethyl-1-methyl-2-propenyloxy, 1-ethyl-2-methyl-1-propenyloxy and 1-ethyl-2-methyl-2-propenyloxy and the like.

C₂-C₁₀-alkenylthio is a C₂-C₁₀-alkenyl group, preferably C₃-C₁₀-alkenyl group, bound via a sulfur atom. Examples of this are 1-propenylthio, 2-propenylthio, 1-methylethenylthio, 1-butenylthio, 2-butenylthio, 3-butenylthio, 1-methyl-1-propenylthio, 2-methyl-1-propenylthio, 1-methyl-2-propenylthio, 2-methyl-2-propenylthio, 1-pentenylthio, 2-pentenylthio, 3-pentenylthio, 4-pentenylthio, 1-methyl-1-butenylthio, 2-methyl-1-butenylthio, 3-methyl-1-butenylthio, 1-methyl-2-butenylthio, 2-methyl-2-butenylthio, 3-methyl-2-butenylthio, 1-methyl-3-butenylthio, 2-methyl-3-butenylthio, 3-methyl-3-butenyl, 1,1-dimethyl-2-propenylthio, 1,2-dimethyl-1′-propenylthio, 1,2-dimethyl-2-propenylthio, 1-ethyl-1-propenylthio, 1-ethyl-2-propenylthio, 1-hexenylthio, 2-hexenylthio, 3-hexenylthio, 4-hexenylthio, 5-hexenylthio, 1-methyl-1-pentenylthio, 2-methyl-1-pentenylthio, 3-methyl-1-pentenylthio, 4-methyl-1-pentenylthio, 1-methyl-2-pentenylthio; 2-methyl-2-pentenylthio, 3-methyl-2-pentenylthio, 4-methyl-2-pentenylthio, 1-methyl-3-pentenylthio, 2-methyl-3-pentenylthio, 3-methyl-3-pentenylthio, 4-methyl-3-pentenylthio, 1-methyl-4-pentenylthio, 2-methyl-4-pentenylthio, 3-methyl-4-pentenylthio, 4-methyl-4-pentenylthio, 1,1-dimethyl-2-butenylthio, 1,1-dimethyl-3-butenylthio, 1,2-dimethyl-1-butenylthio, 1,2-dimethyl-2-butenylthio, 1,2-dimethyl-3-butenylthio, 1,3-dimethyl-1-butenylthio, 1,3-dimethyl-2-butenylthio, 1,3-dimethyl-3-butenylthio, 2,2-dimethyl-3-butenylthio, 2,3-dimethyl-1-butenylthio, 2,3-dimethyl-2-butenylthio, 2,3-dimethyl-3-butenylthio, 3,3-dimethyl-1-butenylthio, 3,3-dimethyl-2-butenylthio, 1-ethyl-1-butenylthio, 1-ethyl-2-butenylthio, 1-ethyl-3-butenylthio, 2-ethyl-1-butenylthio, 2-ethyl-2-butenylthio, 2-ethyl-3-butenylthio, 1,1,2-trimethyl-2-propenylthio, 1-ethyl-1-methyl-2-propenylthio, 1-ethyl-2-methyl-1-propenylthio and 1-ethyl-2-methyl-2-propenylthio and the like.

C₂-C₁₀-alkynyloxy is a C₂-C₁₀-alkynyl group, preferably C₃-C₁₀-alkynyl group, bound via an oxygen atom. Examples of this are 2-propynyloxy, 2-butynyloxy, 3-butynyloxy, 1-methyl-2-propynyloxy, 2-pentynyloxy, 3-pentynyloxy, 4-pentynyloxy, 1-methyl-2-butynyloxy, 1-methyl-3-butynyloxy, 2-methyl-3-butynyloxy, 1-ethyl-2-propynyloxy, 2-hexynyloxy, 3-hexynyloxy, 4-hexynyloxy, 5-hexynyloxy, 1-methyl-2-pentynyloxy, 1-methyl-3-pentynyloxy and the like.

C₂-C₁₀-alkynylthio is a C₂-C₁₀-alkynyl group, preferably C₃-C₁₁-alkynyl group, bound via an oxygen atom. Examples of this are 2-propynylthio, 2-butynylthio, 3-butynylthio, 1-methyl-2-oropynylthio, 2-pentynylthio, 3-pentynylthio, 4-pentynylthio, 1-methyl-2-butynylthio, 1-methyl-3-butynylthio, 2-methyl-3-butynylthio, 1-ethyl-2-propynylthio, 2-hexynylthio, 3-hexynylthio, 4-hexynylthio, 5-hexynylthio, 1-methyl-2-pentynylthio, 1-methyl-3-pentynylthio and the like.

C₂-C₁₀-alkene is a monounsaturated aliphatic hydrocarbon having 2 to 10 carbon atoms. Examples of this are ethene, propene, 1-butene, 2-butene (cis and trans), isobutene, 1- and 2-pentene, 1-, 2- and 3-hexene, 1-, 2- and 3-heptene, 1-, 2-, 3- and 4-octene, 1-, 2-, 3- and 4-nonene and 1-, 2-, 3-, 4- and 5-decene and positional isomers thereof.

Halogenated C₂-C₁₀-alkenes are understood as meaning monounsaturated aliphatic hydrocarbons in which at least one hydrogen atom is substituted by a halogen atom, such as chlorine, bromine or fluorine, in particular chlorine. Examples of these are vinyl fluoride, vinyl chloride, vinyl bromide, allyl chloride, allyl bromide and the like.

C₄-C₁₀-alkadienes are diunsaturated aliphatic hydrocarbons having 4 to 10 carbon atoms, the two double bonds being conjugated or isolated from one another. Examples of these are 1,3-butadiene, 1,3- and 1,4-pentadiene, isoprene, 1,3-, 1,4-, 1,5- and 2,4-hexadiene, 1,3-, 1,4-, 1,5-, 1,6-, 2,4- and 2,5-heptadiene, octadiene, nonadiene, decadiene and positional isomers thereof.

Halogenated C₄-C₁₀-alkadienes are diunsaturated aliphatic hydrocarbons having 4 to 10 carbon atoms in which at least one hydrogen atom is replaced by a halogen atom, such as chlorine, fluorine or bromine and in particular chlorine. An example of these is chloroprene.

C₃-C₁₀-cycloalkyl is an optionally substituted mono or polycyclic cycloalkyl group having 3 to 10 carbon atoms as ring members. Examples of monocyclic groups are cyclopropyl, cyclobutyl, cyclopentyl, cyclohexyl, cycloheptyl, cyclooctyl, cyclononyl and cyclodecyl. Examples of polycyclic groups are norbornyl, decalinyl, adamantyl and the like. Suitable substituents are, for example, C₁-C₆-alkyl, C₁-C₆-alkoxy and halogen.

C₃-C₁₀-cycloalkyl-C₁-C₄-alkyl is a C₁-C₄-alkyl radical, such as methyl, ethyl, propyl, isopropyl, n-butyl, 2-butyl, isobutyl and tert-butyl, which is substituted by a C₃-C₁₀-cycloalkyl radical. Examples of this are cyclopropylmethyl, 1- or 2-cyclopropylethyl, 1-, 2- or 3-cyclopropylpropyl, cyclopentylmethyl, cyclohexylmethyl and the like.

In the context of the present invention, aryl is an aromatic hydrocarbon radical having 6 to 14, carbon atoms, such as phenyl, naphthyl, anthracenyl or phenanthrenyl. The aryl radical may be unsubstituted or may carry from 1 to 4 substituents. Suitable substituents are, for example, C₁-C₆-alkyl, C₁-C₆-haloalkyl, C₁-C₆-alkoxy, C₁-C₆-thioalkyl, halogen, nitro, CN, COOR^{d}, COR^{e}, SO₂OR^{f}, SO₂R^{g}, SR^{h} and NRⁱR^{j}, where R^{d}, R^{e}, R^{f}, R^{g} and R^{h}, independently of one another, are H or C₁-C₆-alkyl and where Rⁱ and R^{j} are H, C₁-C₆-alkyl or C₂-C₆-hydroxyalkyl. Examples of this are phenyl, naphthyl, fluorophenyl, chlorophenyl, bromophenyl, methylphenyl, ethylphenyl, propylphenyl, isopropylphenyl, butylphenyl, isobutylphenyl, tert-butylphenyl, hydroxyphenyl, methoxyphenyl, ethoxyphenyl, propoxyphenyl, isopropoxyphenyl, butoxyphenyl, secbutoxyphenyl, isobutoxyphenyl, tert-butoxyphenyl, nitrophenyl, carboxyphenyl, formylphenyl, acetylphenyl, sulfonylphenyl, methylsulfonylphenyl, sulfonylnaphthyl, methylsulfonylnaphthyl, carboxynaphthyl and the like.

Aryl-C₁-C₄-alkyl is a C₁-C₄-alkyl radical which is substituted by an aryl group as defined above. Examples of this are benzyl and 1- and 2-phenylethyl.

C₂-C₄-alkylene is a linear or branched alkylene group having 2 to 4 carbon atoms. Examples of this are 1,1-ethylene, 1,2-ethylene, 1,2-propylene, 1,3-propylene, 1,2-butylene, 1,4-butylene and the like.

In the context of the present invention, hetaryl is a 5- or 6-membered heteroaromatic having 1 to 4 heteroatoms or heteroatom-containing groups which are selected from O, S, N and NR^{k}, where R^{k} is H or C₁-C₆-alkyl. Examples of this are pyrrolyl, pyrazolyl, imidazolyl, triazolyl, tetrazolyl, furanyl, oxazolyl, isoxazolyl, thienyl, thiazolyl, thiadiazolyl, pyridinyl, pyrimidinyl, pyridazinyl and pyrazinyl. The hetaryl radical may be unsubstituted or may carry from 1 to 4 substituents. Suitable substituents are, for example, C₁-C₆-alkyl, C₁-C₆-haloalkyl, C₁-C₆-alkoxy, halogen, nitro, CN, COOR^{d}, COR^{e}, SO₂OR^{f}, SO₂R^{g}, SR^{h} and NRⁱR^{j}, where R^{d}, R^{e}, R^{f}, R^{g} and R^{h}, independently of one another, are H or C₁-C₆-alkyl and where Rⁱ and R^{j} are H, C₁-C₆-alkyl or C₂-C₆-hydroxyalkyl.

In the context of the present invention, heterocyclyl is a saturated or unsaturated nonaromatic heterocycle having 3 to 10 ring members and 1 to 4 heteroatoms or heteroatom-containing groups which are selected from O, S, N and NR^{l}, where R^{l} is H or C₁-C₆-alkyl, it being possible for the heterocycle also to comprise 1 or 2 carbonyl groups as ring members. Examples of this are oxiranyl, thiiranyl, aziridinyl, oxetanyl, azetidinyl, dihydrofuranyl, tetrahydrofuranyl, dihydrothienyl, tetrahydrothienyl, pyrrolinyl, pyrrolidinyl, pyrrolidinonyl, pyrrolidinedionyl, pyrazolinyl, pyrazolidinyl, pyrazolidinonyl, imidazolinyl, imidazolidinyl, imidazolidinonyl, oxazolinyl, oxazolidinyl, oxazolidinonyl, isoxazolinyl, isoxazolidinyl, isoxazolidinonyl, thiazolinyl, thiazolidinyl, thiadiazolinyl, thiadiazolidinyl, pyranyl, dihydropyranyl, tetrahydropyranyl, piperidinyl, piperazinyl, morpholinyl, thiomorpholinyl, caprolactamyl and the like. Suitable substituents correspond to those mentioned above in the case of hetaryl.

Heterocyclyl-C₁-C₄-alkyl is a C₁-C₄-alkyl radical which is substituted by a heterocyclyl radical. Examples of this are oxiranylmethyl (glycydyl), thiiranylmethyl, aziridinylmethyl, oxetanylmethyl, azetidinylmethyl, dihydrofuranylmethyl, tetrahydrofuranylmethyl, dihydrothienylmethyl, tetrahydrothienylmethyl, pyrrolinylmethyl, pyrrolidinylmethyl, pyrrolidinonylmethyl, pyrazolinylmethyl, pyrazolidinylmethyl, pyrazolidinonylmethyl, imidazolinylmethyl, imidazolidinylmethyl, imidazolidinonylmethyl, oxazolinylmethyl, oxazolidinylmethyl, oxazolidinonylmethyl, isoxazolinylmethyl, isoxazolidinylmethyl, isoxazolidinonylmethyl, thiazolinylmethyl, thiazolidinylmethyl, thiadiazolinylmethyl, thiadiazolidinylmethyl, pyranylmethyl, dihydropyranylmethyl, tetrahydropyranylmethyl, piperidinylmethyl, piperazinylmethyl, morpholinylmethyl, thiomorpholinylmethyl and the like.

In the context of the present invention, halogen is preferably fluorine, chlorine or bromine.

The following statements with regard to preferred developments of the process according to the invention, for example with regard to preferred compounds I, with regard to preferred monomers capable of free radical polymerization, with regard to preferred process measures, etc., are applicable both in isolation and in particular in combination with one another.

In compounds I, R^{a} and R^{b}, independently of one another, are preferably H, formyl, carboxyl, thiocarboxyl, aryl, C₁-C₈₀-alkyl, C₂-C₈₀-alkenyl, C₁-C₁₀-alkylcarbonyl, C₁-C₁₀-alkylthiocarbonyl, C₁-C₁₀-alkyloxycarbonyl or C₁-C₁₀-alkyloxythiocarbonyl, it being possible for alkyl and alkenyl in the six abovementioned radicals to be unsubstituted, to be partially or completely halogenated and/or to carry 1, 2, 3, or 4 identical or different substituents which are selected from OH, C₁-C₁₀-alkoxy, SH, C₁-C₁₀-alkylthio, CN, nitro, amino, C₁-C₁₀-alkylamino, di-(C₁-C₁₀-alkyl)amino, formyl, C₁-C₁₀-alkylcarbonyl, C₁-C₁₀-alkylthiocarbonyl, carboxyl, thiocarboxyl, C₁-C₁₀-alkoxycarbonyl, C₁-C₁₀-alkoxythiocarbonyl, C₁-C₁₀-alkylcarbonyloxy, C₁-C₁₀-alkylthiocarbonyloxy, C₁-C₁₀-alkoxycarbonyloxy, C₁-C₁₀-alkoxythiocarbonyloxy and aryl.

R^{a} and R^{b}, independently of one another, are more preferably H, C₄-C₈₀-alkyl, preferably C₄-C₄₀-alkyl, particularly preferably C₄-C₂₀-alkyl and in particular C₄-C₁₂-alkyl, C₁-C₄-alkyl which may be substituted by 1 or 2 C₁-C₄-alkoxycarbonyl groups or aryl, or aryl.

Aryl is preferably phenyl which is unsubstituted or carries 1 or 2 substituents which are selected from halogen, C₁-C₄-alkyl, C₁-C₄-haloalkyl, C₁-C₄-alkoxy and C₁-C₄-haloalkoxy.

The C₄-C₈₀-, C₄-C₄₀-, C₄-C₂₀- and C₄-C₁₂-alkyl radicals are preferably (poly)isobutyl radicals.

In a particularly preferred embodiment of the invention, R^{a} and R^{b}, independently of one another are H, methyl or a radical of the formula I.a

—[CH₂]ₐ[C(CH₃)₂—CH₂]_{b}—H (I.a),

where a is 0 or 1 and b is a number from 1 to 20, at least one of the radicals R^{a} and R^{b} being a radical of the formula I.a.

In particular, compounds of the formula I.a.1 or I.a.2

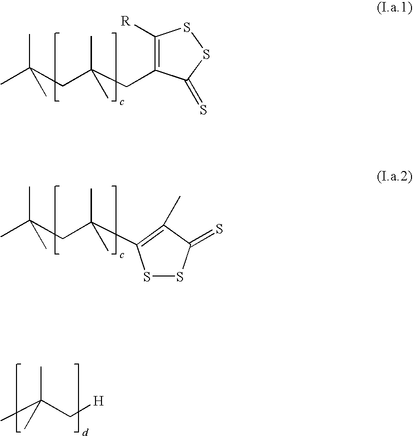

where
R is H or a group,
c is a number from 0 to 19; and
d is a number from 1 to 19,
or mixtures thereof are used as chain transfer agents I in the process according to the invention.
c is preferably a number from 0 to 10, particularly preferably 0, 1, 2, 3 or 4 and in particular 0, 1 or 2.
d is preferably a number from 1 to 10, particularly preferably 1, 2, 3 or 4 and in particular 1 or 2.
R is preferably H.

The compounds I are for the most part known and can be prepared by known processes of the prior-art. Most preparation methods comprise the reaction of suitable hydrocarbons which have a radical R^{a} and/or R^{b} or a precursor thereof with sulfur and/or phosphorus pentasulfide (P₂S₅) at elevated temperature, for example at from 150 to 250° C. Suitable processes are described, for example, in U.S. Pat. No. 2,658,900, U.S. Pat. No. 2,995,569, FR-A-2119511, Arch. Pharm. 324, 131-132 (1991), Chem. Rev. 1965, 65(2), 237, Sulfur Letters 1989, 10(1+2), 31-36, Synthesis 2000, 12, 1749-1755 and Tetrahedron 35, 1339 (1979), and in the literature cited therein, which is hereby fully incorporated by reference.

Thus, compounds of the formula I.a are obtainable, for example, by reacting isobutene oligomers with sulfur at a temperature of from 180 to 250° C., optionally while blowing in inert gas and, optionally, at elevated reaction pressure. Advantageously, the hydrogen sulfide likewise forming in the reaction is at least partly removed.

The preparation of compounds I.a.1 and I.a.2 in which c is in each case 0 and R is H or tert-butyl (d=1) from diisobutene or triisobutene and sulfur is known in principle and is described, for example, in U.S. Pat. No. 2,658,900, U.S. Pat. No. 2,995,569 and FR-A-2119511 and in the literature cited therein, which is hereby fully incorporated by reference.

Compounds I.a.1 and I.a.2 where c is a number≧0 can be prepared analogously to the processes described in U.S. Pat. No. 2,658,900, U.S. Pat. No. 2,995,569 and FR-A-2119511.

Compounds I in which one of the radicals R^{a} or R^{b} is (COOH or alkoxycarbonyl and the other radical is H can be prepared, for example, by reacting an oxalacetic acid diester with sulfur and/or phosphorus pentasulfide at elevated temperature. The reaction of formates with sulfur also leads to such compounds.

Compounds I in which both radicals R^{a} and R^{b} are H can be prepared, for example, by reacting propene with sulfur and/or phosphorous pentasulfide at elevated temperature. The reaction of formates with sulfur also leads to such compounds. The reaction of other olefins which may also be suitably substituted also takes place analogously to give compounds I in which R^{a} and/or R^{b} are optionally substituted alkyl or alkenyl.

Arylvinyl compounds, e.g. styrenes, can be converted analogously into compounds I in which R^{a} or R^{b} is optionally substituted phenyl. Such compounds can also be prepared by reacting isopropyl-substituted aryl compounds with sulfur.

Compounds I in which one of the radicals R^{a} or R^{b} is SH or alkylthio can be obtained, for example, by reacting optionally substituted malonic, acid esters with sulfur and/or phosphorus pentasulfide.

Other compounds I can be prepared analogously to processes of the prior art.

The monomers used in the process according to the invention and capable of free radical polymerization are preferably selected from C₂-C₁₀-alkenes, halogenated C₂-C₁₀-alkenes, C₄-C₁₀-alkadienes, halogenated C₄-C₁₀-alkadienes, compounds of the formula II

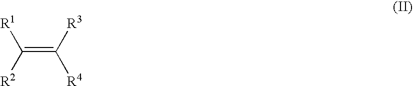

where
R¹ and R² are H, C₁-C₆-alkyl or COR⁵, not more than one of the radicals R¹ or R² being COR⁵;
R³ is H, C₁-C₆-alkyl or CH₂COR⁵, R³ not being CH₂COR⁵ when one of the radicals R¹ or R² is COR⁵;
R⁴ is COR⁵ or CN, R⁴ not being CN when one of the radicals R¹ or R² is COR⁵ or when R³ is CH₂COR⁵; or
R² and R⁴ together form a —CO—O—CO— or —CO—NR^{x}—CO— group where R^{x} is H or C₁-C₁₀-alkyl;
each R⁵, independently of one another, is OR⁶, O⁻(M^{y+})_{1/y} or NR⁷R⁸;
R⁶ is H, C₁-C₂₀-alkyl, C₂-C₁₀-hydroxyalkyl, silyl-substituted C₁-C₁₀-alkyl, amine- or ammonium-substituted C₁-C₁₀-alkyl, sulfo or sulfonate-substituted C₁-C₁₀-alkyl, C₃-C₁₀-cycloalkyl, C₃-C₁₀-cycloalkyl-C₁-C₄-alkyl, aryl, aryl-C₁-C₄-alkyl, heterocyclyl, heterocyclyl-C₁-C₄-alkyl or a group of the formula -A-[X-A]ₘ-R⁹, where
   A is C₂-C₄-alkylene;
   X is O or NR¹⁰;
   R⁹ is OR¹¹ or NR¹²R¹³;
   R¹⁰, R¹² and R¹³ independently of one another, are H, C₁-C₁₀-alkyl or C₂-C₁₀-hydroxyalkyl;
   R¹¹ is H or C₁-C₁₀-alkyl; and
   m is a number from 0 to 10;
(M^{y+})_{1/y} is a metal equivalent or an ammonium ion, where y is 1, 2 or 3;
R⁷ and R⁸, independently of one another, are H, C₁-C₁₀-alkyl, C₂-C₁₀-hydroxyalkyl or a group of the formula -B-[Y-B]ₒ-R¹⁴, where
   B is C₂-C₄-alkylene;
   Y is O or NR¹⁵;
   R¹⁴ is NR¹⁶R¹⁷ or OR¹⁸;
   R¹⁶ and R¹⁷, independently of one another, are H, C₁-C₁₀-alkyl or C₂-C₁₀-hydroxyalkyl;
   R¹⁵ and R¹⁸, independently of one another, are H or C₁-C₁₀-alkyl; and
   o is a number from 0 to 10;
and compounds of the formula III

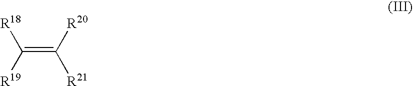

where
R¹⁸, R¹⁹ and R²⁰, independently of one another, are H or C₁-C₆-alkyl; and
R²¹ is OR²², O—(CO)—R²³, N(R²⁵)—(CO)—R²⁴, aryl, hetaryl or heterocyclyl, where
R²² is C₁-C₂₀-alkyl;
R²³ and R²⁴, independently of one another, are H or C₁-C₂₀-alkyl; and
R²⁵ is H or C₁-C₁₀-alkyl;
and mixtures thereof.

In some cases, alkenes which have a branch at one carbon atom of the double bond (so-called isoalkenes) cannot be subjected directly to free radical polymerization. Accordingly, C₂-C₁₀-alkenes which are used in the process according to the invention as monomers capable of free radical polymerization are preferably selected from alkenes which have no branch at the carbon atoms of the double bond, such as linear alkenes and alkenes having a branch at carbon atom which do not belong to the double bond. Preferred C₂-C₁₀-alkenes are accordingly ethene, propene, n-butenes (1- and 2-butene), n-pentenes (1- and 2-pentene), n-hexenes (1-, 2- and 3-hexene), n-heptenes (1-, 2- and 3-heptene), n-octenes (1-, 2-, 3- and 4-octene), n-nonenes (1-, 2-, 3- and 4-nonene) and n-decenes (1-, 2-, 3-, 4- and 5-decene). Particularly preferred C₂-C₁₀-alkenes are ethene and propene.

Preferred halogenated C₂-C₁₀-alkenes which can be used in the process according to the invention as monomers capable of free radical polymerization are vinyl chloride and vinyl bromide and in particular vinyl chloride.

Preferred C₄-C₁₀-alkadienes which can be used in the process according to the invention as monomers capable of free radical polymerization are butadiene and isoprene.

A preferred halogenated C₄-C₁₀-alkadiene which can be used in the process according to the invention as a monomer capable of free radical polymerization is chloroprene.

Compounds of the formula II in which R¹, R² and R³ are hydrogen or C₁-C₆-alkyl and R⁴ is COR⁵ are, where R⁵ is OR⁶, α,β-unsaturated carboxylic acids (R⁶=H) or esters thereof (R⁶≠H). Where R⁵ is O⁻(M^{y+})_{1/y}, the compounds II are the carboxylic acid salts of α,β-unsaturated carboxylic acids. If R⁵ is NR⁷R⁸, the compound II is the amide of an α,β-unsaturated carboxylic acid. If R¹, R² and R³ are simultaneously H and R⁴ is COR⁵, the compound II is acrylic acid or an acrylic acid derivative (salt, ester or amide). If the radical R³ is methyl, the radicals R¹ and R² are H and R⁴ is COR⁵, the compound II is methacrylic acid or a methacrylic acid derivative (salt, ester or amide).

If R⁴ is CN, none of the radicals R¹ and R² is COR⁵ and R³ is not CH₂COR⁵. In this case, the compound II is acrylonitrile or a substituted acrylonitrile, such as methacrylonitrile.

If one of the radicals R¹ or R² is COR⁵, the compound II is an α,β-unsaturated α,β-dicarboxylic acid or a derivative thereof. Where R¹ is COR⁵, the compound II is optionally substituted fumaric acid or an optionally substituted fumaric acid derivative (salt, ester or amide). Where R² is COR⁵, the compound II is optionally substituted maleic acid or an optionally substituted maleic acid derivative (salt, ester or amide).

If R² and R⁴ together form a —CO—O—CO— group, compound II is optionally substituted maleic anhydride. If R² and R⁴ together form a —CO—NR^{x}—CO— group, the compound II is an optionally substituted maleimide.

If both R¹ or R² and R⁴ are a COR⁵ group, the radical R⁵ in the radicals R¹ or R² and R⁴ may have the same or different meanings.

If the radicals R¹ and R² are H or C₁-C₆-alkyl and R³ is CH₂COR⁵, the compound II is optionally substituted itaconic acid or an optionally substituted itaconic acid derivative (salt, ester or amide). If R³ is CH₂COR⁵ and R⁴ is a COR⁵ group, the radical R⁵ in the radicals R³ and R⁴ may have the same or different meanings.

In a preferred embodiment of the invention, all three radials R¹, R² and R³ in compounds of the formula II are H or two of the radicals R¹, R² and R³ are H and the third radical is methyl, and R⁴ is COR⁵, where R⁵ has the above general meanings or the following preferred meanings. This means that the compound II in this preferred embodiment is acrylic acid or an acrylic acid derivative (salt, ester or amide) (R¹, R² and R³=H), methacrylic acid or a methacrylic acid derivative (salt, ester or amide) (R¹, R²=H, R³=methyl), crotonic acid or a crotonic acid derivative (salt, ester or amide) (R¹, R³=H, R²=methyl), or isocrotonic acid or an isocrotonic acid derivative (salt, ester or amide) (R², R³=H, R¹=methyl).

In a second, alternatively preferred embodiment, all three radicals R¹, R² and R³ are H and two of the radicals R¹, R² and R³ are H and the third radical is methyl, and R⁴ is CN; i.e. the compound II in this case is an optionally substituted acrylonitrile.

In a third, alternatively preferred embodiment, the radicals R¹ and R³ are both H or one of the radicals R¹ and R³ is methyl and the other is H, and R² and R⁴ are in each case the radical COR⁵, where R⁵ in the radicals R² and R⁴ may have the same or different meanings and R⁵ has the above general meanings or the preferred meanings mentioned below. In this case, compounds II are maleic acid or maleic acid derivatives (salt, ester or amide) (R¹, R³=H) or citraconic acid or citraconic acid derivatives (salt, ester or amide) (R¹=H, R³=methyl).

In a fourth, alternatively preferred embodiment, the radicals R¹ and R³ are both H or one of the radicals is methyl and the other is H, and R² and R⁴ together form a —CO—O—CO— group; i.e. the compounds II in this case are maleic anhydride (R¹, R³=H) or citraconic anhydride (R¹=H, R³=methyl).

In a fifth, alternatively preferred embodiment, both radicals R¹ and R³ are H and one of the radicals is methyl and the other is H, and the radicals R² and R⁴ together form a —CO—NR^{x}—CO— group, where R^{x} has the abovementioned general meanings or the following preferred meanings. In this case, the compounds II are a maleimide (R¹, R³=H) or a citraconimide (R¹=H, R³=methyl).

In a sixth, alternatively preferred embodiment, the radicals R² and R³ are both H and one of the radicals is methyl and the other is H, and R¹ and R⁴ are a COR⁵ radical, where R⁵ in the two radicals R¹ and R⁴ may have the same or different meaning and where R⁵ has the above general meanings or the following preferred meanings. Accordingly, compounds II are in this case optionally methyl-substituted fumaric acid or an optionally methyl-substituted fumaric acid derivative (salt, ester or amide).

In a seventh, alternatively preferred embodiment, the radicals R¹ and R² are both H and one of the radicals is methyl and the other is H, R³ is a CH₂COR⁵ and R⁴ is a COR⁵, where R⁵ in the two radicals R³ and R⁴ may have the same or different meanings and where R⁵ has the above general meanings or the following preferred meanings. Accordingly, compounds II in this case are optionally methyl-substituted itaconic acid or an optionally methyl-substituted itaconic acid derivative (salt, ester or amide).

In the radical R⁶, in the group of the formula -A-[X-A-]ₘ-R⁹, A is preferably ethylene or 1,2-propylene and in particular is ethylene (—CH₂—CH₂—).

In the group of the formula -A-[X-A-]ₘ-R⁹, X is preferably O and R⁹ is simultaneously OR¹¹, where R¹¹ has the above general meanings or the following preferred meanings. m in this case is preferably a number from 1 to 10, particularly preferably from 1 to 5.

In this case, the COR⁵ (where R⁵ is OR⁶ and R⁶ is -A-[X-A-]ₘ-R⁹) is a carboxylic ester radical which is derived in the alcohol component from poly(etherpoly)ols, such as ethylene glycol, diethylene glycol and triethylene glycol, or monoetherified poly(etherpoly)ols, such as ethylene glycol monomethyl ether, ethylene glycol monoethyl ether, diethylene glycol monomethyl ether, diethylene glycol monoethyl ether, triethylene glycol monomethyl ether and triethylene glycol monoethyl ether.

Alternatively, in the group of the formula -A-[X-A-]ₘ-R⁹, X is preferably NR¹⁰ and R⁹ is simultaneously NR¹²R¹³, where R¹⁰, R¹² and R¹³ have the above general meanings or the following preferred meanings. m is a number from 0 to 10, preferably from 0 to 6.

In this case, the COR⁵ group is an ester group which is derived from an alkanolamine, dialkanolamine or trialkanolamine or from a mono- or polyalkoxylated polyamine, i.e. from a polyamine in which at least one amine nitrogen atom carries at least one hydroxyalkyl group. For example, the ester group in the alcohol component is derived from ethanolamine, N,N-dimethylethanolamine, N,N-diethylethanolamine, diethanolamine, diethanol/methylamine, diethanolethylamine, triethanolamine, N-(2-hydroxyethyl)ethylenediamine, N,N′-(2-hydroxyethyl)ethylenediamine, N-(2-hydroxyethyl)-N′,N′-dimethylethylenediamine, N,N′-(2-hydroxyethyl)ethylenediamine, N-(2-hydroxyethyl)-N′,N′-diethylethylenediamine, N-(2-hydroxyethyl)diethylenetriamine, N,N′-(2-hydroxyethyl)diethylenetriamine, N-(2-hydroxyethyl)-N′,N′-dimethyldiethylenetriamine, N-(2-hydroxyethyl)-N′,N′-diethyldiethylenetriamine and the like.

In the group -A-[X-A-]ₘ-R⁹, X is particularly preferably O and R⁹ is particularly preferably OR¹¹, where A, R⁹ and R¹¹ have the above general or preferred meanings or the following preferred meanings.

R¹¹ is preferably H or C₁-C₄-alkyl, particularly preferably H, methyl or ethyl and in particular H.

R¹⁰, R¹² and R¹³, independently of one another, are preferably H, C₁-C₄-alkyl or C₂-C₄-hydroxyalkyl, particularly preferably H, methyl or ethyl and in particular H.

If R⁶ is aryl, the aryl radical is preferably selected from phenyl which is optionally substituted by 1 to 4 radicals which are selected from C₁-C₆-alkyl, C₁-C₆-haloalkyl, C₁-C₆-alkoxy, halogen, nitro, CN, COOR^{d}, COR^{e}, SO₂OR^{f}, SO₂R^{g}, SR^{h} and NRⁱR^{j}, where R^{d}, R^{e}, R^{f}, R^{g} and R^{h}, independently of one another are H or C₁-C₆-alkyl and where Rⁱ and R^{j}, independently of one another, are H, C₁-C₆-alkyl or C₂-C₆-hydroxyalkyl. Aryl is particularly preferably phenyl or tolyl and in particular phenyl.

If R⁶ is aryl-C₁-C₄-alkyl this radical is preferably selected from benzyl and 2-phenylethyl. In particular, it is benzyl.

If R⁶ is heterocyclyl-C₁-C₄-alkyl, this radical is preferably glycidyl (oxiranylmethyl).

R⁶ is particularly preferably H, C₁-C₂₀-alkyl, especially C₁-C₁₀-alkyl and in particular C₁-C₄-alkyl, C₂-C₁₀-hydroxyalkyl, especially C₂-C₄-hydroxyalkyl, heterocyclyl-C₁-C₄-alkyl, especially glycidyl, aryl, especially phenyl, aryl-C₁-C₄-alkyl, especially benzyl, a group of the formula -A-[O-A]ₘ-OH, where A is preferably ethylene, m is a number from 1 to 4, or a group of the formula -A-[NR¹⁰-A]ₘ-NR¹²R¹³, where A is preferably ethylene, R¹⁰ is preferably H, R¹² and R¹³ are preferably H, methyl or ethyl and m is preferably a number from 0 to 4 and in particular is 0.

In particular, R⁶ is H or C₁-C₁₀-alkyl and especially H or C₁-C₄-alkyl.

(M^{y+})_{1/y} is a metal equivalent or an ammonium ion. y is a number from 1 to 3 and specifies the charge number of the metal cation. Preferred ammonium ions are those of the formula NHR′R″R′″, where R′, R″ and R′″, independently of one another, are H, C₁-C₁₀-alkyl or C₂-C₁₀-hydroxyalkyl. Suitable metal equivalents are the singly or multiply positively charged cations of alkali metals, such as sodium, potassium or lithium, alkaline earth metals, such as calcium and magnesium, metals of the third main group, such as aluminum, and transition metals, such as iron or copper. Preferred metals are alkali metals and alkaline earth metals and in particular alkali metals. Suitable ammonium ions are, for example, the ammonium ion itself (NH₄⁺) and the following amines in protonated form: methylamine, dimethylamine, trimethylamine, ethylamine, diethylamine, triethylamine, propylamine, dipropylamine, tripropylamine, isopropylamine, diisopropylamine, ethyldiisopropylamine, butylamine, dibutylamine, tributylamine, ethanolamine, diethanolamine and triethanolamine, propanolamine, dipropanolamine and tripropanolamine and the like.

(M^{y+})_{1/y} is preferably an alkali metal cation, such as Na⁺ or K⁺.

In the radicals R⁷, and R⁸, in the group of the formula -B-[Y-B-]ₒ-R¹⁴, B is preferably ethylene or 1,2-propylene and in particular ethylene.

Y is preferably NR¹⁵, where R¹⁵ has the abovementioned general meanings or the following preferred meanings.

R¹⁵ is preferably H or C₁-C₄-alkyl, particularly preferably H, methyl or ethyl and in particular H.

R¹⁴ is preferably NR¹⁶R¹⁷ where R¹⁶ and R¹⁷, independently of one another, have the abovementioned general meanings or the following preferred meanings.

R¹⁶ and R¹⁷, independently of one another, are preferably H or C₁-C₄-alkyl, particularly preferably H, methyl or ethyl and in particular H.

o is preferably a number from 0 to 6 and in particular a number from 0 to 4.

If Y is NR¹⁵ and/or R¹⁴ is NR¹⁶R¹⁷, at most R⁸ is a group of the formula -B-[Y-B]ₒ-R¹⁴, while R⁷ is H, C₁-C₁₀-alkyl or C₂-C₁₀-hydroxyalkyl.

If R⁸ is a group of the formula -B-[Y-B]ₒ-R¹⁴ where Y is NR¹⁵ and at the same time o is a number from 1 to 10 and/or R¹⁴ is NR¹⁶R¹⁷, the COR⁵ (R⁵=NR⁷R⁸; R⁷=H, C₁-C₁₀-alkyl or C₂-C₁₀-hydroxyalkyl and R⁸=the abovementioned group) is a carboxamido radical which is derived from a di- or polyamine, such as ethylenediamine, diethylenetriamine, triethylenetetramine, tetraethylenepentamine, etc.

Preferably, R⁷ and R⁸, independently of one another, are H or C₁-C₁₀-alkyl, especially C₁-C₄-alkyl, or R⁷ is H or C₁-C₁₀-alkyl, especially C₁-C₄-alkyl, and R⁸ is a group of the formula -B-[Y-B]ₒ-R¹⁴, where the variables B, Y, R¹⁴ and 6 have the above-mentioned general or preferred meanings. Particularly preferably, R⁷ and R⁸ are both H, both methyl or both ethyl.

Examples of suitable compounds of the formula II are acrylic acid, methacrylic acid, maleic acid, fumaric acid, itaconic acid, the salts of these acids, in particular with sodium, potassium or ammonium as opposition ions, sulfopropyl acrylate (acrylic acid 3-sulfopropyl ester), potassium sulfopropylacrylate (acrylic acid 3-sulfopropyl ester potassium salt), methyl acrylate, ethyl acrylate, propyl acrylate, isopropyl acrylate, n-butyl acrylate, 2-butyl acrylate, isobutyl acrylate, tert-butyl acrylate, 2-ethylhexyl acrylate, lauryl acrylate, isobornyl acrylate, phenyl acrylate, benzyl acrylate, glycidyl acrylate, 2-hydroxyethyl acrylate, 2- and 3-hydroxypropyl-acrylate, 2-, 3- and 4-hydroxybutyl acrylate, N,N-dimethylaminoethyl acrylate, N,N-diethylaminoethyl acrylate, ethylene glycol acrylate, ethylene glycol monomethyl ether acrylate, diethylene glycol acrylate, diethylene glycol monomethyl ether acrylate, triethylene glycol acrylate, triethylene glycol monomethyl ether acrylate, polyethylene glycol acrylate, polyethylene glycol monomethyl ether acrylate, 2-acryloyloxyethyltrimethylammonium chloride, acrylamide, N-methylacrylamide, N,N-dimethylacrylamide, N-ethylacrylamide, N,N-diethylacrylamide, N-tert-butylacrylamide, N-n-butylacrylamide, N-methylolacrylamide, N-ethylolacrylamide, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, (2-oxo-1-pyrrolidinyl)ethyl acrylate, methyl methacrylate, ethyl methacrylate, propyl methacrylate, isopropyl methacrylate, n-butyl methacrylate, 2-butyl methacrylate, isobutyl methacrylate, tert-butyl methacrylate, 2-ethylhexyl methacrylate, lauryl methacrylate, isobornyl methacrylate, phenyl methacrylate, benzyl methacrylate, glycidyl methacrylate, 2-hydroxyethyl methacrylate, 2- and 3-hydroxypropyl-methacrylate, 2-, 3- and 4-hydroxybutyl methacrylate, N,N-dimethylaminoethyl methacrylate, N,N-diethylaminoethyl methacrylate, ethylene glycol methacrylate, ethylene glycol monomethyl ether methacrylate, diethylene glycol methacrylate, diethylene glycol monomethyl ether methacrylate, triethylene glycol methacrylate, triethylene glycol monomethyl ether methacrylate, polyethylene glycol methacrylate, polyethylene glycol monomethyl ether methacrylate, 2-methacryloyloxyethyltrimethylammonium chloride, methacrylamide, N-methylmethacrylamide, N,N-dimethylmethacrylamide, N-ethylmethacrylamide, N,N-diethylmethacrylamide, N-tert-butylmethacrylamide, N-n-butylmethacrylamide, N-methylolmethacrylamide, N-ethylolmethacrylamide, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, (2-oxo-1-pyrrolidinyl)ethyl methacrylate, itaconic anhydride, maleic anhydride, N-methylmaleimide, N-ethylmaleimide, N-propylmaleimide, N-butylmaleimide, N-phenylmaleimide, acrylonitrile and methacrylonitrile.

Preferred compounds of the formula II are those in which R¹ and R² are H and R³ is H or methyl, i.e. particularly preferred compounds of the formula II are acrylic acid, methacrylic-acid, acrylic acid salts, methacrylic acid salts, acrylic acid esters, methacrylic acid esters, acrylamides, methacrylamides, acrylonitrile and methacrylonitrile.

More greatly preferred compounds of the formula II are those in which R¹ and R² are H, R³ is H or methyl and R⁴ is COR⁵; i.e. more greatly preferred compounds II are acrylic acid, methacrylic-acid, acrylic acid-salts, methacrylic acid salts, acrylic acid esters, methacrylic acid esters, acrylamides and methacrylamides.

Particularly preferably, R⁵ is OR⁶ or O⁻(M^{y+})_{1/y}; i.e. even more greatly preferred compounds II are acrylic acid, methacrylic acid, acrylic acid esters, methacrylic acid esters, acrylic acid salts and methacrylic acid salts.

In particular, the compound II is acrylic acid or an acrylic acid ester of C₁-C₂₀-alcohols, such as methyl acrylate, ethyl acrylate, propyl acrylate, isopropyl acrylate, n-butyl acrylate, sec-butyl acrylate, isobutyl acrylate, tert-butyl acrylate, lauryl acrylate and the like.

In compounds III, R¹⁸, R¹⁹ and R²⁰ are preferably H or one of the radicals R¹⁸, R¹⁹ and R²⁰ is methyl and the other two radicals is H. Particularly preferably, all three radicals are H.

Compounds III where R²¹ is OR²² are alkenyl alkyl ethers. They are preferably C₁-C₂₀-alkyl vinyl ethers (R¹⁸, R¹⁹ and R²⁰=H) or C₁-C₁₀-alkyl propenyl ethers (one of the radicals R¹⁸, R¹⁹ and R²⁰ is methyl and the other two radicals are H). In particular, they are C₁-C₁₀-alkyl vinyl ethers. Examples of these are ethyl vinyl ether, propyl vinyl ether, isopropyl vinyl ether, n-butyl vinyl ether, 2-butyl vinyl ether, isobutyl vinyl ether, tert-butyl vinyl ether, pentyl vinyl ether, hexyl vinyl ether, heptyl vinyl ether, octyl vinyl ether, 2-ethylhexyl vinyl ether, nonyl vinyl ether, decyl vinyl ether, undecyl vinyl ether, dodecyl vinyl ether, tridecyl vinyl ether, tetradecyl vinyl ether, pentadecyl vinyl ether, hexadecyl vinyl ether, heptadecyl vinyl ether, octadecyl vinyl ether, nonadecyl vinyl ether, docosyl vinyl ether and positional isomers thereof.

Compounds of the formula III where R²¹ is O—(CO)—R²³ are the alkenyl esters of saturated aliphatic C₁-C₂₁-carboxylic acids. They are preferably the corresponding vinyl or propenyl esters and in particular the vinyl esters. Examples of these are vinyl formate, vinyl acetate, vinyl propionate, vinyl butyrate, vinyl pentanoate, vinyl hexanoate, vinyl heptanoate, vinyl octanoate, vinyl-2-ethylhexanoate, vinyl nonanoate, vinyl decanoate, vinyl laurate, vinyl palmitate, vinyl stearate and the like. A preferred vinyl ester is vinyl acetate.

Compounds of the formula III where R²¹ is N(R²⁵)—(CO)—R²⁴ are the N-alkenylamides of saturated aliphatic C₁-C₂₁-carboxylic acids. They are preferably the corresponding N-vinyl- or N-propenylamides and in particular the N-vinylamides. Examples of these are N-vinylformamide, N-methyl-N-vinylformamide, N-vinylacetamide, N-methyl-N-vinylacetamide, N-vinylpropionamide, N-methyl-N-vinylpropionamide, N-vinylbutyramide, N-methyl-N-vinylbutyramide and the like. A preferred vinylamide is N-vinylformamide.

In the radical R²¹, aryl is preferably phenyl which is unsubstituted or carries from 1 to 4 substituents. Suitable substituents are, for example, C₁-C₄-alkyl, halogen, carboxyl, cyano and nitro. Examples of compounds III where R²¹ is aryl are styrene, α-methylstyrene, 2-, 3- and 4-methylstyrene, 2,6-dimethylstyrene, 2-chlorostyrene, 2-, 3- and 4-vinylbenzoic acid, α-methylvinylbenzoic acid, diethylamino-α-methylstyrene, diethylaminostyrene, p-vinylbenzenesulfonic acid and the like. Preferred compounds III where R²¹ is aryl are styrene, α-methylstyrene and 2-, 3- and 4-methylstyrene.

In the radical R²¹, hetaryl is preferably a 5- or 6-membered heteroaromatic having 1 to 3 heteroatoms or heteroatom-containing groups which are selected from O, S, N and NR^{m}, where R^{m} is H or C₁-C₄-alkyl. The hetaryl group preferably comprises at least one nitrogen atom. Particularly preferably, it comprises no O and no S. The hetaryl group may be bound to the alkenyl group both via a ring carbon atom and via a ring nitrogen atom. Examples of suitable compounds III where R²¹ is hetaryl are N-vinylimidazole, 2-vinylimidazole, N-vinyl-[1.2.4]-1H-triazole, 3-vinyl-[1.2.4]-1H-triazole, N-vinyl-[1.3.4]-1H-triazole, 2-vinyl-[1.3.4]-1H-triazole, vinylpyridine, in particular p-vinylpyridine, and vinylpyridine-N-oxide, in particular p-vinylpyridine-N-oxide.

In the radical R²¹, heterocyclyl is a 3- to 10-membered saturated or unsaturated nonaromatic heterocyclic radical having 1, 2, 3 or 4 heteroatoms which are selected from O, S and N, and, optionally, 1 or 2 carbonyl groups as ring members. Examples of compounds III where R²¹ is heterocyclyl are N-vinylpyrrolidone and N-vinylcaprolactam.

Preferred compounds of the formula III are those in which all three radicals R¹⁸, R¹⁹ and R²⁰ are H or one of the radicals is methyl and the other two are H, and R²¹ is OR²², OCOR²³, N(R²⁵)—CO—R²⁴, aryl or heterocyclyl. Aryl is preferably phenyl optionally substituted as described above, in particular phenyl or 2-, 3-, or 4-methylphenyl. R²³ is preferably methyl. Examples of preferred compounds of the formula III are C₁-C₂₀-alkyl vinyl ethers, especially C₁-C₁₀-alkyl vinyl ethers, the vinyl esters of saturated aliphatic C₁-C₂₁-carboxylic acids, especially of saturated aliphatic C₁-C₁₁-carboxylic-acids, in particular vinyl acetate, the N-vinylamides of saturated aliphatic C₁-C₂₁-carboxylic acids, especially of saturated aliphatic C₁-C₁₁-carboxylic acids, in particular N-vinyl formamide, N-vinyl-substituted heterocycles, especially N-vinylpyrrolidone and N-vinylcaprolactam, styrene, α-methylstyrene and 2-, 3- and 4-methylstyrene.

The monomers capable of free radical polymerization are particularly preferably selected from C₂-C₁₀-alkenes, compounds of the formula II and compounds of the formula III. These can also be used in combination with one another. Reference is hereby made to the above statements regarding suitable and preferred C₂-C₁₀-alkenes, compounds of the formula II and compounds of the formula III. The particularly preferred monomers can also be used in combination with other monomers capable of free radical polymerization, preferably with the abovementioned preferred monomers, namely with halogenated C₂-C₁₀-alkenes, C₄-C₁₀-alkadienes and/or halogenated C₄-C₁₀-alkadienes.

At least one compound of the formula II, optionally in combination with at least one further monomer capable of free radical polymerization, is more preferably used in the process according to the invention as a monomer capable of free radical polymerization. Said monomer is preferably selected from the abovementioned preferred monomers, i.e. from C₂-C₁₀-alkenes, halogenated C₂-C₁₀-alkenes, C₄-C₁₀-alkadienes, halogenated C₄-C₁₀-alkadienes, other compounds of the formula II and compounds of the formula III. Regarding suitable and preferred compounds of the formula II and also of the formula III, reference is made to the above statements. Particularly preferred monomers which can be polymerized in combination with the at least one compound II are selected from C₂-C₁₀-alkenes, ethene and propene being preferred among these, and compounds of the formula III, those in which all three radicals R¹⁸, R¹⁹ and R²⁰ are H or one of the radicals is methyl and the other two are H, and R²¹ is OR²², OCOR²³ or aryl, being preferred among these. Here, aryl is preferably phenyl which is optionally substituted as described above, in particular phenyl or 2-, 3- or 4-methylphenyl.

In particular, the process according to the invention serves for the preparation of homo- or copolymers of acrylic acid, methacrylic acid, acrylic acid derivatives or methacrylic acid derivatives and in particular of acrylic acid or acrylic acid derivatives. If the process according to the invention is used for the preparation of copolymers of acrylic acid, methacrylic acid, acrylic acid derivatives or methacrylic acid derivatives, preferred comonomers are selected from compounds II which differ from the acrylic acid, methacrylic acid, acrylic acid derivatives or methacrylic acid derivatives used as the first monomer, C₂-C₁₀-alkenes, especially ethylene and propylene, and compounds of the formula III, especially C₁-C₁₀-alkyl vinyl ethers, styrene, α-methylstyrene, 2-, 3- and 4-methylstyrene and the vinyl esters of saturated aliphatic C₁-C₁₁-carboxylic acids, such as vinyl acetate.

In particular, the process according to the invention serves for the homo- or copolymerization of acrylic acid, in particular with another compound of the formula II.

Suitable free radical initiators, which are also referred to as initiators are all initiator systems used in the classical free radical polymerization. These include compounds which decompose homolytically on thermal excitation, such as peroxides, peroxyesters or azo compounds, redox initiator systems, photochemical initiator systems and high-energy radiation, such as electron beams, X-rays or γ-ray radiation. The initiator system is advantageously chosen so that no adverse interactions with the chain transfer agent occurs under the given reaction conditions. In addition the initiator should advantageously be soluble in the chosen reaction medium or in the monomer mixture.

Examples of suitable azo compounds are 2,2′-azobisisobutyronitrile, 2,2′-azobis(2-cyano-2-butane), dimethyl 2,2′-azobis(isobutyrate), 4,4′-azobis(4-cyanopentoic acid), 4,4′-azobis(cyanopentan-1-ol), 1,1′-azobis(cyclohexanecarbonitrile), 2,2′-azobis(2,4-dimethylvaleronitrile), 2,2′-azobis(4-methoxy-2,4-dimethylvaleronitrile), 2-(carbamoylazo)isobutyronitrile, 2,2′-azobis(2-methylbutyronitrile), 2-(t-butylazo)-2-cyanopropane, 2,2′-azobis[2 methyl-N-(1,1)-bis(hydroxymethyl)-2-hydroxyethyl]-propionamide, 2,2′-azobis[2-methyl-N-hydroxyethyl]-propionamide, 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramidine), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide) dihydrate, 2,2′-azobis(2,2,4-trimethylpentane), 2,2′-azobis(2-methylpropane).

Examples of suitable peroxy compounds are tert-butyl peroxyacetate, tert-butyl peroxybenzoate, tert-butyl peroxyoctanoate, tert-butyl peroxyneodecanoate, tert-butyl peroxyisobutyrate, tert-amyl peroxypivalate, tert-butyl peroxypivalate, diisopropyl peroxydicarbonate, dicyclohexyl peroxydicarbonate, dicumyl peroxide, dibenzyl peroxide, dilauroyl peroxide, sodium peroxydisulfate, potassium peroxydisulfate and ammonium peroxydisulfate.

The photochemical initiator systems include benzoin derivatives, benzophenone, arylphosphine oxides and photo-redox systems.

Redox initiator systems consist as a rule of a combination of at least one oxidizing agent with at least one reducing agent. Suitable oxidizing agents are, for example, potassium peroxydisulfate, hydrogen peroxide and tert-butyl hydroperoxide. Suitable reducing agents are, for example, iron(II) salts, titanium(III) salts, potassium thiosulfite and potassium bisulfite.

Preferably used free radical initiators are homolytically cleavable compounds, azo compounds being particularly preferred among these. In particular, one of the abovementioned azo compounds is used.

The amount of free radical initiator to be used depends, inter alia on the desired molecular weight, the desired polydispersity and polymer structure of the polymer to be obtained. However, it is used as a rule in an amount of not more than 10% by weight, preferably in an amount of from 0.001 to 5% by weight, based on the total weight of the monomers to be polymerized.

In order to keep the concentration of free radicals in the reaction zone as low as possible and hence to permit a controlled free radical polymerization, the chain transfer agent must be present in excess compared with the initiator (free radical initiator). If a compound which decomposes into two radicals as a result of homolysis is chosen as the free radical initiator the ratio of chain transfer reagent to initiator must be at least 2:1. Depending on the monomers to be polymerized, however, substantially higher molar ratios of chain transfer agent to free radical initiator are also required. The ratio which is most advantageous in each case for a controlled free radical polymerization of the monomer or monomer mixture to be polymerized in each case can be determined in the individual case by the person skilled in the art by means of simple preliminary experiments.

The molar ratio of chain transfer agent to free radical initiator is preferably at least 2:1, e.g. from 2:1 to 100:1 or from 2:1 to 10:1, particularly preferably at least 3:1, e.g. from 3:1 to 100:1 or from 3:1 to 10:1, for example about 4:1 or about 5:1.

The polymerization process according to the invention can be used for the preparation of homopolymers and random copolymers but in particular also of block copolymers, gradient copolymers and other complex polymer architectures.

Whereas as a rule random copolymers are prepared by a procedure in which the comonomers to be polymerized, which however must have similar reactivity, are added substantially simultaneously, the individual comonomers are added in succession in the desired sequence for the preparation of block copolymers. The addition of the respective next comonomer is advantageously effected only when the previously added comonomer has been substantially completely consumed, so that “clean” blocks, i.e. blocks composed substantially of a single comonomer, form. In the process according to the invention, it is even possible to isolate and to store comonomer blocks and to react them only subsequently with further comonomers. If the polymerization is in fact not terminated by classical termination reactions, the living polymer chains, which are terminated at their ends in each case by the dithiolthiones I (and “sleep”), can be isolated, for example by removing monomers still present and, optionally, solvent present, the “sleeping” polymer chains remaining behind. These can then be reactivated as soon as desired, for example thermally, and, for example, reacted with further comonomers or with a desired terminal group. This procedure can of course also be used in the case of homopolymers or random copolymers for introducing a certain terminal group.

For the preparation of gradient copolymers, comonomers to be polymerized which have different reactivity (polymerization rate) under the given reaction conditions are added simultaneously to the polymerization reaction.

Regarding the preparation of star polymers, the reference is made to the process described in J. Pol. Sci. Polym. Chem. 2003, 41, 365, and the literature cited therein.

The polymerization process according to the invention can be carried out as mass polymerization, solution polymerization, emulsion polymerization or suspension polymerization by the batch, semibatch, continuous or feed procedure.

The emulsion and suspension polymerizations are carried out as a rule in an aqueous medium which may comprise customary assistants, such as stabilizers, dispersants and other additives.

In the solution polymerization, the choice of the solvent depends in particular on the monomer to be polymerized. Very generally, nonpolar solvents, such as aliphatic hydrocarbons, e.g. pentane, hexane, heptane, octane and cyclohexane, or aromatic hydrocarbons, such as benzene, toluene, chlorobenzene and the xylenes, are more suitable for nonpolar monomers. Accordingly, more polar solvents, such as ketones, e.g. acetone, methyl ethyl ketone, methyl isobutyl ketone or methyl amyl ketone, esters, such as ethyl acetate and propyl acetate, glycol ethers, such as diethylene glycol and triethylene glycol, open-chain ethers, such as diethyl ether, methyl-tert-butyl ether and diisopropyl ether, and cyclic ethers, such as tetrahydrofuran and dioxane, are (also) suitable for more polar monomers. For the copolymerization of more polar and nonpolar comonomers, said more polar solvents are preferably used. For strongly polar monomers, water is also suitable. For the monomers of the formula II particularly preferably used in the process according to the invention and the monomer mixtures comprising them, water and the abovementioned more polar solvents and in particular water and the cyclic-ethers are particularly suitable.

When carrying out the reaction, it is preferable to adopt a procedure in which the chain transfer agent is added before the polymerization is initiated, i.e. the chain transfer agent is preferably added before the free radical initiator. This is intended to permit as effective control as possible over the course of the polymerization.

The polymerization process according to the invention can be carried out according to known processes of the prior art for controlled free radical polymerization, as described for example, in WO 2004/014967, US-A-2003/0195310, EP-A-1205492, WO 2004/056880 and in particular in WO 99/311.44 and in the references cited in these documents, which is hereby fully incorporated by reference. In principle, the procedure can also be effected analogously to known free radical polymerization techniques, the substantial difference being in the use of the chain transfer agent.

The present invention furthermore relates to the use of a compound of the formula I or of a mixture thereof as a chain transfer agent in controlled free radical polymerization reactions. In particular, these controlled free radical polymerization reactions are so-called RAFT polymerizations. Regarding preferred compounds I and suitable or preferred monomers and reaction conditions, reference is made to the above statements.

Finally, the invention relates to a polymer which is obtainable by the process according to the invention and which is terminated by a group which is derived from the compound I. “Terminated” means that the polymer carries, at the chain end which is opposite that chain end from which the chain growth was started, a bound group which is derived from a compound I and which forms as a result of the reaction of a living chain end with this compound. The polymers according to the invention are distinguished by a narrow molecular weight distribution. Thus, the PDI is preferably not more than 2.0, particularly preferably not more than 1.5 and in particular not more than 1.3. Moreover, they are distinguished by the fact that they can be reactivated at any time, for example by thermal excitation and addition of a free radical initiator, and they can then be further reacted, for example with further monomers or comonomers.

The data on number average and weight average molecular weights Mₙ and M_{w} and the polydispersity index (PDI=M_{w}/Mₙ) relate to values measured by gel permeation chromatography (GPC). Standards used thereby are the standards customary for the respective (co)polymers, e.g. water in the case of polyacrylic acid or polystyrene in the case of (co)polymers which are not water-soluble.

The polymers obtainable by the process according to the invention are distinguished by a narrow molecular weight distribution. Thus, the PDI is preferably not more than 2.0, particularly preferably not more than 1.5 and in particular not more than 1.3. Moreover, they are distinguished by an exactly defined and predeterminable polymer architecture, for example by comonomer blocks thoroughly delimited from one another in block copolymers or by a defined increase or decrease in the concentration of the individual comonomers in gradient copolymers.

The compounds I and their mixtures act as effective chain transfer agents in the free radical polymerization and are not inferior in any way in their activity to the chain transfer agents of the prior art. Since, however, the compounds of the formula I can be prepared simultaneously easily and economically they enable controlled free radical polymerizations to be carried out substantially more economically than the processes of the prior art, which rely on expensive dithio compounds which are difficult to prepare as chain transfer agents. At the same time, the advantages of the classical free radical polymerization, namely, inter alia, the wide range of polymerizable monomers, the low demands with respect to the purity of the reactants and the simplicity of the process design, are retained.

The following examples are intended to illustrate the invention but without limiting it.

### EXAMPLES

### Example 1

### Polymerization of Acrylic Acid

72 g (1 mol) of acrylic acid and 10.22 g (0.05 mol) of a mixture of 4-neopentyl-1,2-dithiol-4-cyclopentene-3-thione (compound of the formula I.a.1, in which R is H and c is 0) and 4-methyl-5-tert-butyl-1,2-dithiol-4-cyclopentene-3-thione were dissolved in 200 ml of dioxane in a 1 l flask with a reflux condenser and gas inlet tube, nitrogen being blown continuously through the solution. The mixture was heated to 100° C. and 1.222 g (5 mmol) of 1,1′-azobis(cyclohexanecarbonitrile) were added and stirring was then effected for 3 h. After cooling to room temperature, the volatile constituents (solvent and unconverted acrylic acid) were evaporated at 1 mbar and 100° C. 30 g (80%) of a yellow-brown water-soluble powder was obtained, which was investigated by means of ¹H-NMR in D₂O. The product had six acrylic acid units per molecule of chain transfer agent. The number average molecular weight Mₙ was 2600 and the polydispersity index (PDI=M_{w}/Mₙ) was 1.3.

### Example 2

### Evidence for the Effect of the Compounds I as Chain Transfer Agents

72 g (1 mol) of acrylic acid and 10.22 g (0.05 mol) of a mixture of 4-neopentyl-1,2-dithiol-4-cyclopentene-3-thione and 4-methyl-5-tert-butyl-1,2-dithiol-4-cyclopentene-3-thione were dissolved in 500 ml of dioxane in a 1 l flask with a reflux condenser and gas inlet tube, nitrogen being blown continuously through the reaction solution. The mixture was heated to 70° C. and 1.242 g (5 mmol) of 2,2′-azobis(2,4-dimethylvaleronitrile) were added and stirring was then effected for 3 h. After cooling to room temperature, the volatile constituents (solvent and unconverted acrylic acid) were evaporated at 1 mbar and 100° C. 16 g of a brown powder which was not soluble in water were obtained, which powder was investigated by means of ¹H-NMR in CDCl₃. No acrylic acid units were found. This means that the polymerization did not take place although initiator had been added. This shows that the radical formed reacts immediately with the thioester group of the chain transfer agent and that higher temperatures are required in order to cleave this adduct again so that the polymerization of acrylic acid can progress. This proves that the thio compounds used act as chain transfer agents.

### Example 3

### Preparation of an Acrylic Acid/Butyl Acrylate Block Copolymer

10 g (about 15 mmol) of the “sleeping” acrylic acid polymer from example 1 and 38.4 g (0.3 mol) of butyl acrylate were dissolved in 50 ml of dioxane in a 1 l flask with a reflux condenser and gas inlet tube, nitrogen being blown continuously through the reaction solution. The mixture was heated to 80° C. and 0.288 g (1.5 mmol) of 2,2′-azobis(2-methylbutyronitrile) was added and stirring was then effected for 3 h. After cooling to room temperature the volatile constituents (solvent and unconverted butyl acrylate) were evaporated at 1 mbar and 100° C. 12.7 g (28% of theory) of a red-brown, hard waxy powder were obtained, which was investigated by means of ¹H-NMR in CD₃OD. The product had six acrylic acid units and 5 butyl acrylate units per molecule of chain transfer agent.

1. A process for the preparation of polymers by controlled free radical polymerization, in which at least one monomer capable of free radical polymerization is polymerized in the presence of at least one free radical initiator and at least one chain transfer agent of the formula I 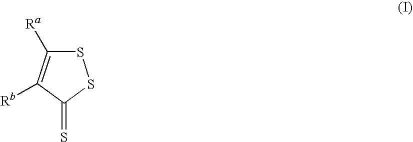
where
R^{a} and R^{b}, independently of one another, are H, halogen, OH, SH, CN, nitro, amino, formyl, carboxyl, thiocarboxyl (—C(S)OH), dithiocarboxyl (CSSH), aryl, C₁-C₈₀-alkyl, C₂-C₈₀-alkenyl, C₂-C₈₀-alkynyl, C₁-C₁₀-alkyloxy, C₂-C₁₀-alkenyloxy, C₂-C₁₀-alkynyloxy, C₁-C₁₀-alkylthio, C₂-C₁₀-alkenylthio, C₂-C₁₀-alkynylthio, C₁-C₁₀-alkylcarbonyl, C₁-C₁₀-alkylthiocarbonyl, C₁-C₁₀-alkylcarbonyloxy, C₁-C₁₀-alkylthiocarbonyloxy, C₁-C₁₀-alkyloxycarbonyl, C₁-C₁₀-alkyloxythiocarbonyl, C₁-C₁₀-alkyloxycarbonyloxy, C₁-C₁₀-alkyloxythiocarbonyloxy, C₁-C₁₀-alkylamino or di(C₁-C₁₀-alkyl)amino, it being possible for alkyl, alkenyl and alkynyl in the 19 abovementioned radicals to be unsubstituted, to be partly or completely halogenated and/or to carry 1, 2, 3 or 4 identical or different substituents which are selected from OH, C₁-C₁₀-alkoxy, SH, C₁-C₁₀-alkylthio, CN, nitro, amino, C₁-C₁₀-alkylamino, di(C₁-C₁₀-alkyl)amino, formyl, C₁-C₁₀-alkylcarbonyl, C₁-C₁₀-alkylthiocarbonyl, carboxyl, thiocarboxyl, C₁-C₁₀-alkoxycarbonyl, C₁-C₁₀-alkoxythiocarbonyl, C₁-C₁₀-alkylcarbonyloxy, C₁-C₁₀-alkylthiocarbonyloxy, C₁-C₁₀-alkoxycarbonyloxy, C₁-C₁₀-alkoxythiocarbonyloxy and aryl,
or R^{a} and R^{b}, together with the carbon atoms to which they are bonded, form a 5- or 6-membered saturated or unsaturated ring which may comprise 1, 2 or 3 heteroatoms which are selected from O, S and N and/or 1 or 2 carbonyl groups as ring members, it being possible for the ring to carry 1, 2 or 3 substituents which are selected from halogen, OH, C₁-C₄-alkyl, C₁-C₄-halo alkyl, C₁-C₄-alkoxy and C₁-C₄-haloalkoxy,
and, optionally, at least one solvent.

2. The process according to claim 1, R^{a} and R^{b}, independently of one another, being H, formyl, carboxyl, thiocarboxyl, aryl, C₁-C₈₀-alkyl, C₂-C₈₀-alkenyl, C₁-C₁₀-alkylcarbonyl, C₁-C₁₀-alkylthiocarbonyl, C₁-C₁₀-alkyloxycarbonyl or C₁-C₁₀-alkyloxythiocarbonyl, it being possible for alkyl and alkenyl in the 6 abovementioned radicals to be unsubstituted, to be partly or completely halogenated and/or to carry 1, 2, 3 or 4 identical or different substituents which are selected from OH, C₁-C₁₀-alkoxy, SH, C₁-C₁₀-alkylthio, CN, nitro, amino, C₁-C₁₀-alkylamino, di(C₁-C₁₀-alkyl)amino, formyl, C₁-C₁₀-alkylcarbonyl, C₁-C₁₀-alkylthiocarbonyl, carboxyl, thiocarboxyl, C₁-C₁₀-alkoxycarbonyl, C₁-C₁₀-alkoxythiocarbonyl, C₁-C₁₀-alkylcarbonyloxy, C₁-C₁₀-alkylthiocarbonyloxy, C₁-C₁₀-alkoxycarbonyloxy, C₁-C₁₀-alkoxythiocarbonyloxy and aryl.

3. The process according to claim 2, R^{a} and R^{b}, independently of one another, being H, methyl or a radical of the formula I.a
—[CH₂]ₐ[C(CH₃)₂—CH₂]_{b}—H (I.a)
where a is 0 or 1 and b is a number from 1 to 20, at least one of the radicals R^{a} and R^{b} being a radical of the formula I.a.

4. The process according to claim 3, b being 1 or 2.

5. The process according to claim 1, the monomers capable of free radical polymerization being selected from C₂-C₁₀-alkenes, halogenated C₂-C₁₀-alkenes, C₄-C₁₀-alkadienes, halogenated C₄-C₁₀-alkadienes, compounds of the formula II 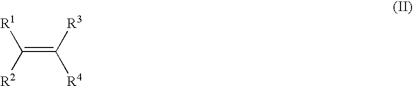
where
R¹ and R² are H, C₁-C₆-alkyl or COR⁵, not more than one of the radicals R¹ or R² being COR⁵;
R³ is H, C₁-C₆-alkyl or CH₂COR⁵, R³ not being CH₂COR⁵ when one of the radicals R¹ or R² is COR⁵;
R⁴ is COR⁵ or CN, R⁴ not being CN when one of the radicals R¹ or R² is COR⁵ or when R³ is CH₂COR⁵; or
R² and R⁴ together forming a —CO—O—CO— or —CO—NR^{x}—CO— group, where R^{x} is H or C₁-C₁₀-alkyl;
each R⁵ is independently OR⁶, O⁻(M^{y+})_{1/y} or NR⁷R⁸;
R⁶ is H, C₁-C₂₀-alkyl, C₂-C₁₀-hydroxyalkyl, silyl-substituted C₁-C₁₀-alkyl, amine- or ammonium-substituted C₁-C₁₀-alkyl, sulfo- or sulfonate-substituted C₁-C₁₀-alkyl, C₃-C₁₀-cycloalkyl, C₃-C₁₀-cycloalkyl-C₁-C₄-alkyl, aryl, aryl-C₁-C₄-alkyl, heterocyclyl, heterocyclyl-C₁-C₄-alkyl or a group of the formula -A-[X-A]ₘ-R⁹, where
A is C₂-C₄-alkylene;
X is O or NR¹⁰;
R⁹ is OR¹¹ or NR¹²R¹³;
R¹⁰, R¹² and R¹³, independently of one another, are H, C₁-C₁₀-alkyl C₂-C₁₀-hydroxyalkyl;
R¹¹ is H or C₁-C₁₀-alkyl; and
m is a number from 0 to 10;
(M^{y+})_{1/y} is a metal equivalent or an ammonium ion, y being a number from 1 to 3;
R⁷ and R⁸, independently of one another, are H, C₁-C₁₀-alkyl, C₂-C₁₀-hydroxyalkyl or a group of the formula -B-[Y-B]ₒ-R¹⁴, where
B is C₂-C₄-alkylene;
Y is O or NR¹⁵;
R¹⁴ is NR¹⁶R¹⁷ or OR¹⁸;
R¹⁶ and R¹⁷, independently of one another, are H, C₁-C₁₀-alkyl or C₂-C₁₀-hydroxyalkyl;
R¹⁵ and R¹⁸, independently of one another, are H or C₁-C₁₀-alkyl; and
o is a number from 0 to 10;
is a number from 0 to 10; 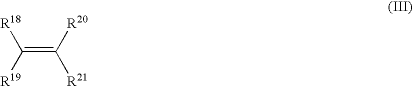
where
R¹⁸, R¹⁹ and R²⁰, independently of one another, are H or C₁-C₆-alkyl; and
R²¹ is OR²², O—(CO)—R²³, N(R²⁵)—(CO)—R²⁴, aryl, hetaryl or heterocyclyl, wherein
R²² is C₁-C₂₀-alkyl;
R²³ and R²⁴, independently of one another, are H or C₁-C₂₀-alkyl; and
R²⁵ is H or C₁-C₁₀-alkyl;
and mixtures thereof.

6. The process according to claim 5, the monomers capable of free radical polymerization being selected from C₂-C₁₀-alkenes, compounds of the formula II, compounds of the formula III and mixtures thereof.

7. The process according to claim 6, R¹ and R² being H, R³ being H or methyl and R⁴ having the meanings stated in claim 5 in compounds of the formula II.

8. The process according to claim 5, R¹⁸, R¹⁹ and R²⁰ being H or one of the radicals R¹⁸, R¹⁹ or R²⁰ being methyl and the other two radicals being H, and R²¹ being OR²², O—(CO)—R²³, N(R²⁵)—(CO)—R²⁴, aryl or heterocyclyl in compounds III.

9. The process according to claim 6, the polymers capable of free radical polymerization being selected from at least one compound of the formula II and, optionally, at least one C₂-C₁₀-alkene and/or at least one compound of the formula III.

10. The process according to claim 9, the compound of the formula II being selected from acrylic acid, methacrylic acid, acrylic acid derivatives and methacrylic acid derivatives.

11. The process according to claim 1, the polymerization being carried out in the presence of a solvent.

12. The method of controlling a free radical polymerization reaction comprising using a compound of formula I according to claim 1 as a chain transfer agent.

13. A polymer obtainable by a process according to claim 1, which is terminated by a group which is derived from the compound I.

14. The process according to claim 2, the monomers capable of free radical polymerization being selected from C₂-C₁₀-alkenes, halogenated C₂-C₁₀-alkenes, C₄-C₁₀-alkadienes, halogenated C₄-C₁₀-alkadienes, compounds of the formula II 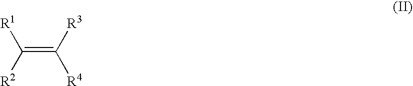
where
R¹ and R² are H, C₁-C₆-alkyl or COR⁵, not more than one of the radicals R¹ or R² being COR⁵;
R³ is H, C₁-C₆-alkyl or CH₂COR⁵, R³ not being CH₂COR⁵ when one of the radicals R¹ or R² is COR⁵;
R⁴ is COR⁵ or CN, R⁴ not being CN when one of the radicals R¹ or R² is COR⁵ or when R³ is CH₂COR⁵; or
R² and R⁴ together forming a —CO—O—CO— or —CO—NR^{x}—CO— group, where R^{x} is H or C₁-C₁₀-alkyl;
each R⁵ is independently OR⁶, O⁻(M^{y+})_{1/y} or NR⁷R⁸;
R⁶ is H, C₁-C₂₀-alkyl, C₂-C₁₀-hydroxyalkyl, silyl-substituted C₁-C₁₀-alkyl, amine- or ammonium-substituted C₁-C₁₀-alkyl, sulfo- or sulfonate-substituted C₁-C₁₀-alkyl, C₃-C₁₀-cycloalkyl, C₃-C₁₀-cycloalkyl-C₁-C₄-alkyl, aryl, aryl-C₁-C₄-alkyl, heterocyclyl, heterocyclyl-C₁-C₄-alkyl or a group of the formula -A-[X-A]ₘ-R⁹, where
A is C₂-C₄-alkylene;
X is O or NR¹⁰;
R⁹ is OR¹¹ or NR¹²R¹³
R¹⁰, R¹² and R¹³, independently of one another, are H, C₁-C₁₀-alkyl C₂-C₁₀-hydroxyalkyl;
R¹¹ is H or C₁-C₁₀-alkyl; and
m is a number from 0 to 10;
(M^{y+})_{1/y} is a metal equivalent or an ammonium ion, y being a number from 1 to 3;
R⁷ and R⁸, independently of one another, are H, C₁-C₁₀-alkyl, C₂-C₁₀-hydroxyalkyl or a group of the formula -B-[Y-B]ₒ-R¹⁴, where
B is C₂-C₄-alkylene;
Y is O or NR¹⁵;
R¹⁴ is NR¹⁶R¹⁷ or OR¹⁸;
R¹⁶ and R¹⁷, independently of one another, are H, C₁-C₁₀-alkyl or C₂-C₁₀-hydroxyalkyl;
R¹⁵ and R¹⁸, independently of one another, are H or C₁-C₁₀-alkyl; and
is a number from 0 to 10;
is a number from 0 to 10; 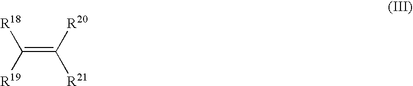
where
R¹⁸, R¹⁹ and R²⁰, independently of one another, are H or C₁-C₆-alkyl; and
R²¹ is OR²², O—(CO)—R²³, N(R²⁵)—(CO)—R²⁴, aryl, hetaryl or heterocyclyl, wherein
R²² is C₁-C₂₀-alkyl;
R²³ and R²⁴, independently of one another, are H or C₁-C₂₀-alkyl; and
R²⁵ is H or C₁-C₁₀-alkyl;
and mixtures thereof.

15. The process according to claim 3, the monomers capable of free radical polymerization being selected from C₂-C₁₀-alkenes, halogenated C₂-C₁₀-alkenes, C₄-C₁₀-alkadienes, halogenated C₄-C₁₀-alkadienes, compounds of the formula II 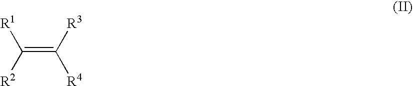
where
R¹ and R² are H, C₁-C₆-alkyl or COR⁵, not more than one of the radicals R¹ or R² being COR⁵;
R³ is H, C₁-C₆-alkyl or CH₂COR⁵, R³ not being CH₂COR⁵ when one of the radicals R¹ or R² is COR⁵;
R⁴ is COR⁵ or CN, R⁴ not being CN when one of the radicals R¹ or R² is COR⁵ or when R³ is CH₂COR⁵; or
R² and R⁴ together forming a —CO—O—CO— or —CO—NR^{x}—CO— group, where R^{x} is H or C₁-C₁₀-alkyl;
each R⁵ is independently OR⁶, O⁻(M^{y+})_{1/y} or NR⁷R⁸;
R⁶ is H, C₁-C₂₀-alkyl, C₂-C₁₀-hydroxyalkyl, silyl-substituted C₁-C₁₀-alkyl, amine- or ammonium-substituted C₁-C₁₀-alkyl, sulfo- or sulfonate-substituted C₁-C₁₀-alkyl, C₃-C₁₀-cycloalkyl, C₃-C₁₀-cycloalkyl-C₁-C₄-alkyl, aryl, aryl-C₁-C₄-alkyl, heterocyclyl, heterocyclyl-C₁-C₄-alkyl or a group of the formula -A-[X-A]ₘ-R⁹, where
A is C₂-C₄-alkylene;
X is O or NR¹⁰;
R⁹ is OR¹¹ or NR¹²R¹³;
R¹⁰, R¹² and R¹³, independently of one another, are H, C₁-C₁₀-alkyl C₂-C₁₀-hydroxyalkyl;
R¹¹ is H or C₁-C₁₀-alkyl; and
m is a number from 0 to 10;
(M^{y+})_{1/y} is a metal equivalent or an ammonium ion, y being a number from 1 to 3;
R⁷ and R⁸, independently of one another, are H, C₁-C₁₀-alkyl, C₂-C₁₀-hydroxyalkyl or a group of the formula -B-[Y-B]ₒ-R¹⁴, where
B is C₂-C₄-alkylene;
Y is O or NR⁵;
R¹⁴ is NR¹⁶R¹⁷ or OR¹⁸;
R¹⁶ and R¹⁷, independently of one another, are H, C₁-C₁₀-alkyl or C₂-C₁₀-hydroxyalkyl;
R¹⁵ and R¹⁸, independently of one another, are H or C₁-C₁₀-alkyl; and
o is a number from 0 to 10;
is a number from 0 to 10; 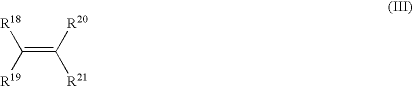
where
R¹⁸, R¹⁹ and R²⁰, independently of one another, are H or C₁-C₆-alkyl; and
R²¹ is OR²², O—(CO)—R²³, N(R²⁵)—(CO)—R²⁴, aryl, hetaryl or heterocyclyl, wherein
R²² is C₁-C₂₀-alkyl;
R²³ and R²⁴, independently of one another, are H or C₁-C₂₀-alkyl; and
R²⁵ is H or C₁-C₁₀-alkyl;
and mixtures thereof.

16. The process according to claim 4, the monomers capable of free radical polymerization being selected from C₂-C₁₀-alkenes, halogenated C₂-C₁₀-alkenes, C₄-C₁₀-alkadienes, halogenated C₄-C₁₀-alkadienes, compounds of the formula II 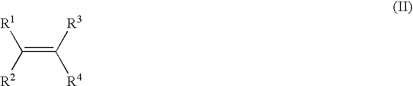
where
R¹ and R² are H, C₁-C₆-alkyl or COR⁵, not more than one of the radicals R¹ or R² being COR⁵;
R³ is H, C₁-C₆-alkyl or CH₂COR⁵, R³ not being CH₂COR⁵ when one of the radicals R¹ or R² is COR⁵;
R⁴ is COR⁵ or CN, R⁴ not being CN when one of the radicals R¹ or R² is COR⁵ or when R³ is CH₂COR⁵; or
R² and R⁴ together forming a —CO—O—CO— or —CO—NR^{x}—CO— group, where R^{x} is H or C₁-C₁₀-alkyl;
each R⁵ is independently OR⁶, O⁻(M^{y+})_{1/y} or NR⁷R⁸;
R⁶ is H, C₁-C₂₀-alkyl, C₂-C₁₀-hydroxyalkyl, silyl-substituted C₁-C₁₀-alkyl, amine- or ammonium-substituted C₁-C₁₀-alkyl, sulfo- or sulfonate-substituted C₁-C₁₀-alkyl, C₃-C₁₀-cycloalkyl, C₃-C₁₀-cycloalkyl-C₁-C₄-alkyl, aryl, aryl-C₁-C₄-alkyl, heterocyclyl, heterocyclyl-C₁-C₄-alkyl or a group of the formula -A-[X-A]ₘ-R⁹, where
A is C₂-C₄-alkylene;
X is O or NR¹⁰;
R⁹ is OR¹¹ or NR¹²R¹³;
R¹⁰, R¹² and R¹³, independently of one another, are H, C₁-C₁₀-alkyl C₂-C₁₀-hydroxyalkyl;
R¹¹ is H or C₁-C₁₀-alkyl; and
m is a number from 0 to 10;
(M^{y+})_{1/y} is a metal equivalent or an ammonium ion, y being a number from 1 to 3;
R⁷ and R⁸, independently of one another, are H, C₁-C₁₀-alkyl, C₂-C₁₀-hydroxyalkyl or a group of the formula -B-[Y-B]ₒ-R¹⁴, where
B is C₂-C₄-alkylene;
Y is O or NR⁵;
R¹⁴ is NR¹⁶R¹⁷ or OR¹⁸;
R¹⁶ and R¹⁷, independently of one another, are H, C₁-C₁₀-alkyl or C₂-C₁₀-hydroxyalkyl;
R¹⁵ and R¹⁸, independently of one another, are H or C₁-C₁₀-alkyl; and
o is a number from 0 to 10;
is a number from 0 to 10; 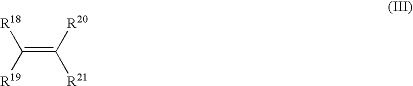
where
R¹⁸, R¹⁹ and R²⁰, independently of one another, are H or C₁-C₆-alkyl; and
R²¹ is OR²², O—(CO)—R²³, N(R²⁵)—(CO)—R²⁴, aryl, hetaryl or heterocyclyl, wherein
R²² is C₁-C₂₀-alkyl;
R²³ and R²⁴, independently of one another, are H or C₁-C₂₀-alkyl; and
R²⁵ is H or C₁-C₁₀-alkyl;
and mixtures thereof.

17. The process according to claim 6, R¹⁸, R¹⁹ and R²⁰ being H or one of the radicals R¹⁸, R¹⁹ or R²⁰ being methyl and the other two radicals being H, and R²¹ being OR²², O—(CO)—R²³, N(R²⁵)—(CO)—R²⁴, aryl or heterocyclyl in compounds III.

18. The process according to claim 7, R¹⁸, R¹⁹ and R²⁰ being H or one of the radicals R¹⁸, R¹⁹ or R²⁰ being methyl and the other two radicals being H, and R²¹ being OR²², O—(CO)—R²³, N(R²⁵)—(CO)—R²⁴, aryl or heterocyclyl in compounds III.

19. The process according to claim 7, the polymers capable of free radical polymerization being selected from at least one compound of the formula II and, optionally, at least one C₂-C₁₀-alkene and/or at least one compound of the formula III.

20. The process according to claim 8, the polymers capable of free radical polymerization being selected from at least one compound of the formula II and, optionally, at least one C₂-C₁₀-alkene and/or at least one compound of the formula III.
